(19) United States
(12) Patent Application Publication
(10) Pub. No.: US 2025/0030308 A1
(43) Pub. Date: Jan. 23, 2025

(54) ENERGY STORAGE UNIT INCLUDING MULTIPLE KINETIC CELLS TO SUPPLY ELECTRICAL POWER THEREFROM

(71) Applicant: Spinning Reserve, LLC, Cut Off, LA (US)

(72) Inventors: Jan Mikalsen, Covington, LA (US); Stein Aase, Cut Off, LA (US)

(21) Appl. No.: 18/669,454

(22) Filed: May 20, 2024

Related U.S. Application Data
(60) Provisional application No. 63/467,891, filed on May 19, 2023.

(51) Int. Cl. H02K 7/02; H02J 15/00; H02K 1/2706; H02K 5/02; H02K 7/12; H02K 11/00; H02K 11/215; H02K 15/08

(52) U.S. Cl. CPC H02K 7/025; H02J 15/007; H02K 1/2706; H02K 5/02; H02K 7/125; H02K 11/0094; H02K 11/215; H02K 15/08; H02K 2203/09; H02K 2213/03; H02K 2213/12

(57) ABSTRACT

An energy storage unit may include multiple kinetic cells that store kinetic energy by use of a rotating, levitating mass to provide large amounts of electrical energy therefrom. The kinetic cells may use air bearings to support the levitating mass in a frictionless state. In an embodiment, the air bearings may be aerodynamic air bearings that enable the mass to self-levitate when rotating, thereby enabling the energy storage unit to be transported without the kinetic cells being charged.

### RELATED APPLICATIONS

This application claims priority to co-pending U.S. Provisional Patent Application having Application No. 63/467,891 filed on May 19, 2023; the contents of which are incorporated herein by reference in their entirety.

### BACKGROUND

Transportation systems, such as marine vessels, use a variety of different power sources. Most transportation systems use fossil fuel-based engines to propel and electronically power the transportation systems. Such fossil fuel-based engines create emissions are generally deemed “environmentally unfriendly.” As an example, marine vessels generally use diesel engines for powering propulsion, thrusters, and electrical systems of the marine vessels. However, diesel engines are inefficient, expensive to operate, cause vibrations throughout the vessels, and produce undesirably high emissions. In most cases, marine vessels that are parked offshore use diesel power to maintain the marine vessels in a stationary, idling position as well as powering the electrical and electronic equipment of the marine vessels. It is common for active shipping ports, such as those in Singapore, to have several hundred marine vessels parked offshore while waiting for dock space, and such idling is very expensive and produces extremely high emissions. Similar situations exist for other transportation systems, such as automobiles, buses, trains, and airplanes.

Consequently, a variety of transportation vehicles, such as marine vessels, have begun using rechargeable batteries. Rechargeable batteries, however, are expensive and use rare Earth minerals, which have negative consequences for the environment from which the rare Earth minerals are mined. Moreover, rechargeable batteries tend to have limited range and are time consuming to recharge. Further, rechargeable batteries have a limited lifespan and include hazardous waste materials that result in dangerous pollution when discarded. Another limiting factor of rechargeable batteries is that heat can damage the batteries or other electrical equipment used to support the rechargeable batteries. As such, there is a need for a power source that does not produce high emissions, is less expensive to operate, has a long lifespan, does not result in pollution when discarded, is less affected by elevated temperatures, is able to be recharged faster with lower risk of a catastrophic event, and includes rare Earth minerals that are more readily available than those used for rechargeable batteries.

One such rechargeable power source is a flywheel. Because of the amount of energy needed to power a marine vessel or other transportation vehicle, high amounts of electrical energy output from flywheels, such as 500 kilowatt-hours or higher, may be utilized to minimize footprint. However, large flywheels can have a number of limitations, such as heat generation, weight, precision and stabilization tolerances due to the use of magnetic levitation, and so on. Such flywheels also have magnetic coupling challenges due to misalignments when vibration and other external forces are applied to the flywheels. Additionally, the large flywheels with heavy rotors present dangers in the event of a catastrophic event (e.g., malfunction, transportation vehicle crash, etc.) that could potentially cause the rotor to escape from a housing of the flywheel. A rotor that is spinning at a high speed (e.g., 30 KHz) may cause catastrophic damage to people or property (e.g., cut through a hull of a marine vessel). As such, there is a need for an energy storage system that avoids such limitations and challenges of large flywheels.

### BRIEF SUMMARY

To overcome the inefficiencies and emissions of fossil fuel-based engines and challenges of large flywheels used in transportation systems, an energy storage unit may include multiple kinetic cells that store kinetic energy by use of a rotating, levitating mass to collectively provide large amounts of electrical energy therefrom. The kinetic cells may use air bearings to support the levitating mass in a frictionless state while rotating. In an embodiment, the air bearings may be aerodynamic air bearings that enable the mass to self-levitate when rotating, thereby enabling the energy storage unit to be transported without the kinetic cells being charged, thereby simplifying shipping or otherwise transporting the energy storage unit. The kinetic cells may be operated at high speeds (e.g., over 200,000 revolutions per minute (200K RPMs), such as 235K RPMs or 960 meters per second) so that the large amounts of electrical energy (e.g., over 250 watt-hours (Wh) per kinetic cell) may be stored. In an alternative embodiment, the kinetic cells may be operated at higher speeds, such as 500K RPMs, 1M RPMs, or otherwise. In an embodiment, 1,000 or more kinetic cells may be housed on a single structure, thereby storing large amounts of kinetic energy and supplying large amounts of electrical energy (e.g., 250 Kilo Watt-hours (KWh), 1 MWh, etc.) when charged. And, because the individual kinetic cells may be small (e.g., about 10 cm (less than 4-inches high) and are housed within very strong casings and canisters, risk of damage to equipment and people resulting from a catastrophic failure of a kinetic cell or transportation vehicle crash is minimal.

Moreover, by using kinetic cells that are relatively small, the ability to use common sized kinetic cells in different numbers and configurations of frames and housings may enable adoption into and powering of transportation vehicles of all types and sizes, such as electric bicycles, scooters, automobiles, trucks, boats, marine vessels, and airplanes, may be possible. Additionally, mobile power plants, power supplies, uninterruptable power supplies, or otherwise, may be provided by the energy storage unit with the kinetic cells. The individual kinetic cells may be charged relatively quickly (e.g., each within a minute and thousand(s) within an hour). Hence, charging some or all of the kinetic cells in an energy storage unit is relatively fast as compared to other forms of rechargeable energy devices (e.g., lithium-ion batteries). The speed at which an entire energy storage system with 1,000 kinetic cells may be charged is dependent upon the amount of electrical power available to be delivered simultaneously to the kinetic cells. More specifically, the amount of time to charge each of the 1,000 kinetic cells may be based on a number of factors, including, but not limited to, amount of electrical power to be delivered to the kinetic cells, size of the electrical conductors, electrical conductors and devices in the energy storage unit, and so on.

One embodiment of an energy storage unit may include multiple kinetic cells configured to be charged by rotating a levitating mass and discharged by generating electrical power utilizing the rotating, levitating mass. A structure may be configured to support the kinetic cells, and an electrical bus may be connected to the kinetic cells to conduct electrical signals to and from the kinetic cells to respectively charge and discharge the kinetic cells.

An energy storage device may include a rotor including a mass and configured to be levitated and rotated, a stator, and a casing disposed around the rotor and stator, and configured to seal the rotor and stator therein.

One embodiment of a system may include an electrical power system configured to conduct electrical power to electrical equipment. At least one energy storage unit may include multiple kinetic cells configured to be charged by rotating a levitating mass and discharged by generating electrical power utilizing the rotating levitating mass. A structure may be configured to support the kinetic cells. At least one electrical conductor, such as a bus, may be connected to the kinetic cells of the at least one energy storage unit. The electrical conductor(s) may be configured to conduct electrical signals to and from the kinetic cells of the energy storage unit(s) to respectively charge and discharge the kinetic cells of the respective at least one energy storage unit, the at least one electrical conductor further in electrical communication to conduct electrical power from the at least one storage unit to the electrical power system. The system may be a marine vessel or other transportation vehicle. Alternatively, the system may be a charging station. Still yet, the system may be a residential property, commercial property, military equipment or property, or otherwise.

One method of charging and discharging an energy storage unit may include applying an electrical signal to charge multiple kinetic cells contained in the energy storage unit by rotating a levitating mass contained within each kinetic cell. An electrical power signal may be generated utilizing the rotating levitating mass, thereby discharging the rotating, levitating mass. The electrical power signal may be conducted to an electrical power system.

Another embodiment of an energy storage unit including a flywheel, including a stator assembly, a rotor assembly positioned radially within the stator assembly, and including multiple rotor magnets, the rotor assembly utilizing an air bearing aligned with a central axis of the stator assembly to rotate about a central axis. A coil of one or more conductive wires may be axially wrapped around the stator assembly. Circuitry may be in electrical communication with the coil, and be configured to selectably (i) apply a voltage to the coil to cause a motor magnetic field to cause at least one of the rotor magnets of the rotor assembly to rotate the rotor assembly within the stator assembly, (ii) receive a generator magnetic field from the rotor magnets while the rotor assembly is rotating, and (iii) conduct an electric current induced on the coil by the magnetic field from the coil to at least one electrical conductor.

Another embodiment of an energy storage unit may include a stator defined by an internal wall, an external wall, a first end, and a second end. A rotor may be defined by an internal wall, an external wall, a first end, and a second end. The external wall of the rotor may be disposed within the internal wall of the stator such that an air bearing is formed within an air gap therebetween. A coil may extend longitudinally around the stator and rotor, and configured to collect magnetic energy generated when the rotor is rotating. A first base may be connected to the first end of the stator, and a second base may be connected to the second end of the stator. The first and second bases may seal the rotor within a cavity defined by (i) the internal wall of the stator, (ii) the first base, and (iii) the second base.

One embodiment of a method of manufacturing an energy storage unit may include forming a flywheel including forming a stator assembly having a tubular shape. A rotor assembly including a plurality of rotor magnets may be formed. The rotor assembly may be disposed radially within the stator assembly. An air bearing that enables the rotor assembly to rotate in a contactless manner may be formed. A coil of one or more conductive wires may be axially wound around the stator assembly with the rotor assembly disposed therein.

One embodiment of operating an energy storage unit may include applying a direct current (DC) voltage to a coil configured to cause a magnetic field to drive rotation of a rotor assembly (i) inclusive of a plurality of permanent magnets and (ii) disposed within a stator assembly of a flywheel to rotate, the rotation of the rotor assembly being facilitated by an air bearing between the rotor assembly and stator assembly. Application of the DC voltage to the coil may be stopped. An electric current may be generated in response to a rotating magnetic field produced by the rotating permanent magnets of the rotor assembly passing through the coil. The electric current may be output from the energy storage unit, such as to an inverter electrically coupled to a power bus or other electrical conductors.

### BRIEF DESCRIPTION OF THE FIGURES

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of an illustrative barge on which an electrical power system operates and is inclusive of energy storage units inclusive of multiple kinetic cells for use in storing kinetic energy when charged and distributing electrical energy therefrom;

FIG. 2 is an illustration of an illustrative marine vessel on which an electrical power system operates and is inclusive of energy storage units inclusive of multiple kinetic cells for use in storing kinetic energy and distributing electrical energy therefrom;

FIG. 3 is an illustration of an illustrative automobile on which an electrical power system operates and is inclusive of energy storage units inclusive of multiple kinetic cells for use in storing kinetic energy and distributing electrical energy therefrom;

FIGS. 4A, 4B-1, and 4B-2 are illustrations of illustrative energy storage units inclusive of multiple kinetic cells for use in storing kinetic energy and distributing electrical energy therefrom;

FIGS. 4C-1 and 4C-2 are illustrations of an illustrative kinetic cells contained within a fixture for mounting within a structure, such as shown in respective FIGS. 4B-1, and 4B-2;

FIG. 5 is an illustration of another illustrative energy storage unit inclusive of multiple kinetic cells for use in storing kinetic energy and distributing electrical energy therefrom;

FIG. 6 is an illustration of an illustrative energy storage unit inclusive of multiple kinetic cells along with a controller that controls charging, maintaining, and discharging the kinetic cells;

FIGS. 7A-7C are illustrations of an illustrative kinetic cell;

FIG. 7D is an illustration of an illustrative canister in which a stator, rotor, and casing of FIGS. 7A-7C, the canister preventing the contents therein from exiting in the event of a catastrophic failure during operation to avoid damage to other equipment or injury to people;

FIGS. 8A and 8B are respective top view and side view illustrations of an illustrative kinetic cell including components stator, rotor, and casing;

FIGS. 9A and 9B are illustrations of a portion of an illustrative kinetic cell including a rotor and casing;

FIG. 10 is an illustration of a brushless DC motor of a kinetic cell inclusive of a simplified view of a motor driver;

FIG. 11 is an illustration of an illustrative ferrite rod core high-frequency coil inductor and rod inductors;

FIG. 12 is an illustration of an illustrative graph inclusive of a set of signals that are used to charge and discharge a kinetic energy cell;

FIG. 13 is an illustration of an illustrative barge on which an electrical power system inclusive of energy storage units inclusive of kinetic cells for use in storing kinetic energy and distributing electrical power therefrom operates;

FIG. 14 is an illustration of an illustrative charging buoy that may be connected to an electrical power generation system, such as on a marine platform, inclusive of kinetic energy storage units via an electrical conductor, and be electrically connected to multiple electrical conductors that may be simultaneously connected in parallel to marine vessels and/or other systems for supplying electrical power to electrical equipment (e.g., ship control systems, radar systems, electrical propulsion systems, etc.) and/or recharging rechargeable batteries thereon;

FIGS. 15A-15Y are illustrations of an illustrative alternative flywheel and components thereof;

FIG. 16 is an illustration of an illustrative flywheel including a stator assembly and a rotor assembly, which may have the same or similar configuration as the stator and rotor assemblies as previously shown and described, including startup magnets;

FIG. 17A is an illustration of an illustrative flywheel assembly including a stator and rotor assembly, motor/generator electromagnetic coils, and electronics for use in “charging” or spinning up the rotor assembly;

FIG. 17B is an illustration of a set of flywheel assemblies that have respective electromagnetic coils in electrical communication with circuitry for input and output of electrical current to and from the coils;

FIG. 18 is an electrical schematic of an illustrative kinetic cell or energy storage device including driver electronics and a flywheel assembly; and

FIGS. 19A and 19B are illustrations of illustrative rotors charging states while charging a flywheel that are being charged using coils.

### DETAILED DESCRIPTION OF THE INVENTION

To provide for clean, rechargeable energy for use in powering transportation systems and operating as power plants, an energy storage unit may include multiple kinetic cells that store kinetic energy by use of a rotating, levitating mass to collectively provide large amounts of electrical energy therefrom. A kinetic cell may be a device configured with a rotating, levitating mass with energy charged orbits (ECOs), where the ECOs maintain kinetic energy (rotational momentum) of the rotating, levitating mass that is convertible to electrical energy using an electromagnetic generator. The electromagnetic generator may be a brushless DC motor, for example. Kinetic cells may be aggregated and supported by a cabinet or other structure. The kinetic cells may be operated independent of one another and be individually or group addressable so as to charge and discharge each one or in a group. In an embodiment, electrical switches may be disposed on a power bus to enable charging and discharging of one or more kinetic cells. Alternatively, each of the kinetic cells may include electrical switches that are selectably turned ON and OFF to enable respective kinetic cells to be charged (increase to full energy charged orbits) and discharged (draw electrical power from the kinetic cells). It should be understood that non-network addressed kinetic cells may be utilized and the kinetic cells may be charged and discharged in the aggregate (e.g., some or all kinetic cells charged, discharged, or kinetic energy maintained in parallel).

The kinetic cells of an energy storage unit may have the same or different specifications (e.g., size, structure, materials, functionality, etc.). The kinetic cells may use air bearings to support the levitating mass in a frictionless state. Being frictionless means that substantially all friction due to contact of components in a kinetic cell while operating is substantially eliminated. Being substantially eliminated may mean that low amounts of air friction of the air bearing may exist. Air bearings have a coefficient of friction u, which is resistance to motion between the surface and the substrate when an air film is present. The coefficient is a very low value for aerodynamic bearings and estimated to be from 0.0 to 0.0001 (as compared to plain bearings having a coefficient of 0.1 and rolling bearings of 0.001). A certain amount of air friction may exist due to operating in 1 ATM. In an embodiment, the air bearings may be aerodynamic air bearings that enable the mass to self-levitate when rotated, thereby enabling the energy storage unit to be transported without the kinetic cells being charged and not be damaged. The use of aerodynamic air bearings avoids the need for forced air to be provided to the kinetic cells. Rather than using air, other gases, such as an inert gas (e.g., Nitrogen, Hydrogen, etc.) or combination of gases, may be used to potentially further reduce air friction. In an alternative embodiment, the kinetic cells may have aerostatic air bearings that use forced air to levitate the rotating mass.

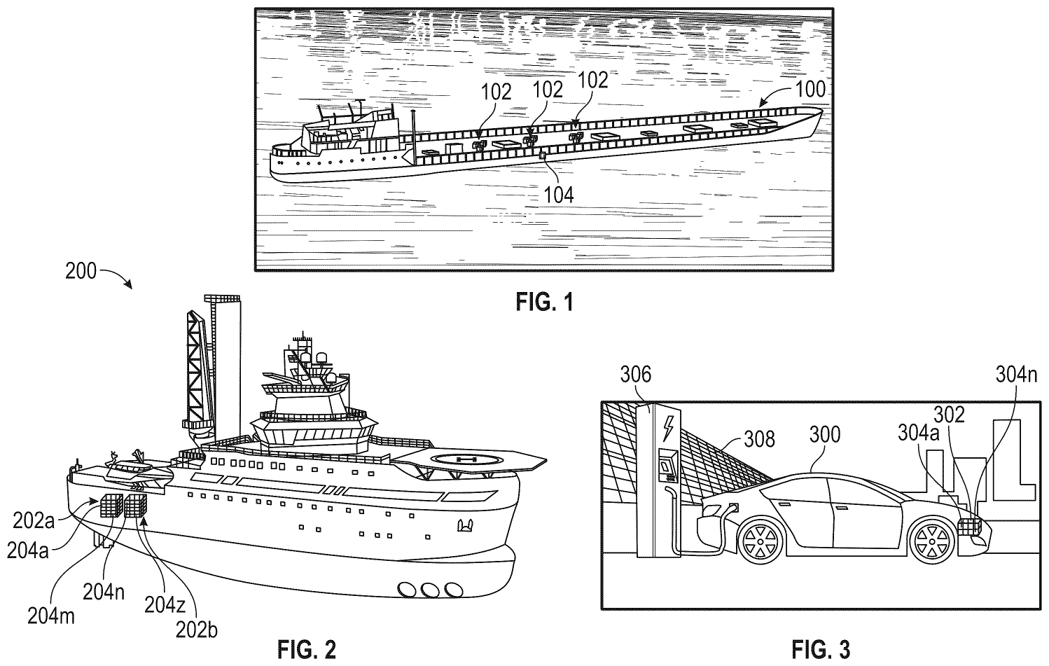

With regard to FIG. 1, an illustration of an illustrative marine vessel or barge 100 on which an electrical power system operates and is inclusive of energy storage units 102 inclusive of multiple kinetic cells for use in storing kinetic energy and distributing electrical energy or power therefrom is shown. The energy storage units 102 may be mounted to the deck and/or below deck, thereby enabling the barge 100 to serve both as a conventional barge for moving cargo and functioning as a power station. In an embodiment, the barge 100 may be configured as just a power station (i.e., no space to transport cargo). This type of barge 100 may be configured to store many energy storage units 102 onboard. The energy storage units 102 may be connected to an electrical power system inclusive of input and output electrical ports 104 for receiving electrical power to recharge the kinetic cells of the energy storage units 102 by causing rotors of the kinetic cells to increase spin rates to maximize kinetic energy. Alternatively, the barge 100 may be a passive barge and be pushed and/or pulled using towboats and include the electrical power system, as previously described.

Depending on the size of the barge 100, upwards of 300 or more energy storage units 102 may be positioned on the barge and be used for storing kinetic energy and delivering electrical power by the kinetic cells. Each of the energy storage units 102 may be charged fast (e.g., within 60 minutes) and store significant kinetic energy that may be utilized to output electrical power (e.g., 250 KWh or higher per energy storage unit depending on a number of kinetic cells and configuration of the kinetic cells). Charging some or all of the energy storage units 102 on the barge 100 may be performed very fast (e.g., 60 minutes with parallel charging to a few hours for sequentially charging groups of energy storage units 102 depending on the configuration of the electrical power grid and available supply of electrical power). In addition, energy from the onboard energy storage units 102 may be used to power electrical thrust system(s) used to propel the barge 100 or maintain the barge 100 in a stationary or parked position.

With regard to FIG. 2, an illustration of an illustrative marine vessel 200 on which an electrical power system operates and is inclusive of energy storage units 202a and 202b (collectively 202) inclusive of multiple kinetic cells 204a-204m and 204n-204z (collectively 204) for use in storing kinetic energy and distributing electrical power therefrom is shown. The number and sizes of kinetic cells 204 in the different energy storage units 202a and 202b may be the same or different. Moreover, although shown as two energy storage units 202, it should be understood that one or more energy storage units may be utilized. The number of energy storage units 202 may be determined based on electrical energy specifications of the marine vessel 200 over a time period (e.g., electrical energy consumption over a maximum amount of time projected between recharging of the kinetic cells 204 of the energy storage units 202). The marine vessel 200 may use the energy storage units 202 to power electrical equipment on the marine vessel 200 and electrical thrusters used to propel the marine vessel 200. An electrical system (not shown) may be utilized to charge the kinetic cells 204 of the energy storage units 202 from an onboard power system (e.g., diesel engine) or off-board power system (e.g., on-shore power grid or renewable energy source), and to enable the energy storage units 202 to supply electrical power to the onboard or an off-board electrical power system.

With regard to FIG. 3, an illustration of an illustrative electric vehicle 300 (e.g., automobile) that includes at least one energy storage unit 302 inclusive of multiple kinetic cells 304a-304n (collectively 304) is shown. The kinetic cells 304 may have the same or different specifications as those used by the energy storage units 202 of the marine vessel of FIG. 2. In this case, because the electric vehicle 300 uses kinetic cells 304 rather than conventional electric batteries (e.g., lithium ion battery), the amount of time to recharge the kinetic cells 304 by an electric charger 306 may be significantly less (e.g., less than a minute to charge each of the kinetic cells 304 and less than 5 or 10 minutes to charge or recharge all of the kinetic cells 304 depending on the number and current charge of the kinetic cells 304). As shown, solar panels 308 may be used to supply power to the electric charger 306 that may include (i) a rechargeable battery (not shown) to store electricity or (ii) an energy storage unit with kinetic cells to store kinetic energy for conversion to electricity for supplying to the electric vehicle 300 to charge the kinetic cells 304.

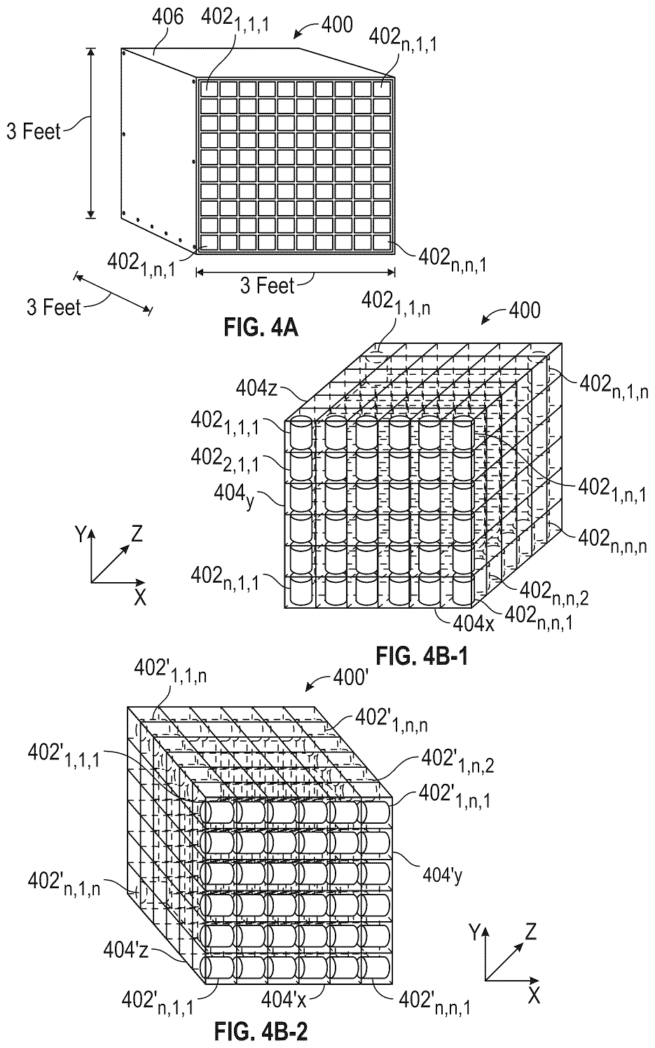

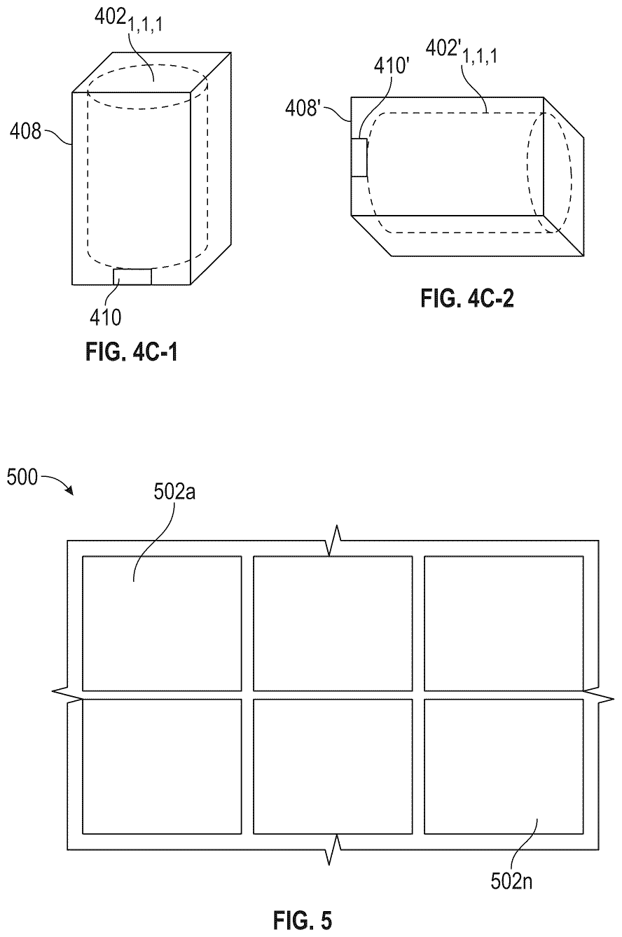

With regard to FIG. 4A, an illustration of an illustrative energy storage unit 400 inclusive of multiple kinetic cells 402_{1,1,1}-402_{n,n,n} (collectively 402) arranged in three-dimensions is shown. The energy storage unit 400 may be cubic or have any other shape and configuration. For example, it should be understood that the energy storage unit 400 may alternatively include kinetic cells arranged in one or two dimensions. In an embodiment, the energy storage unit 400 may be 27 cubic feet (e.g., 3 feet (about 91 cm) long (X-axis) by three feet high (Y-axis) by three feet deep (Z-axis)). The number of kinetic cells 402 may be upwards of 1,000 or more in such a configuration depending on the dimensions of the kinetic cells 402. If, for example, the dimensions of the kinetic cells 402 have a maximum dimension of 4-inches (e.g., 3-inches×3-inches×4-inches), then over 1,000 kinetic cells 402 may be supported by the energy storage unit 400. Larger or smaller energy storage units with more or fewer kinetic cells may be utilized.

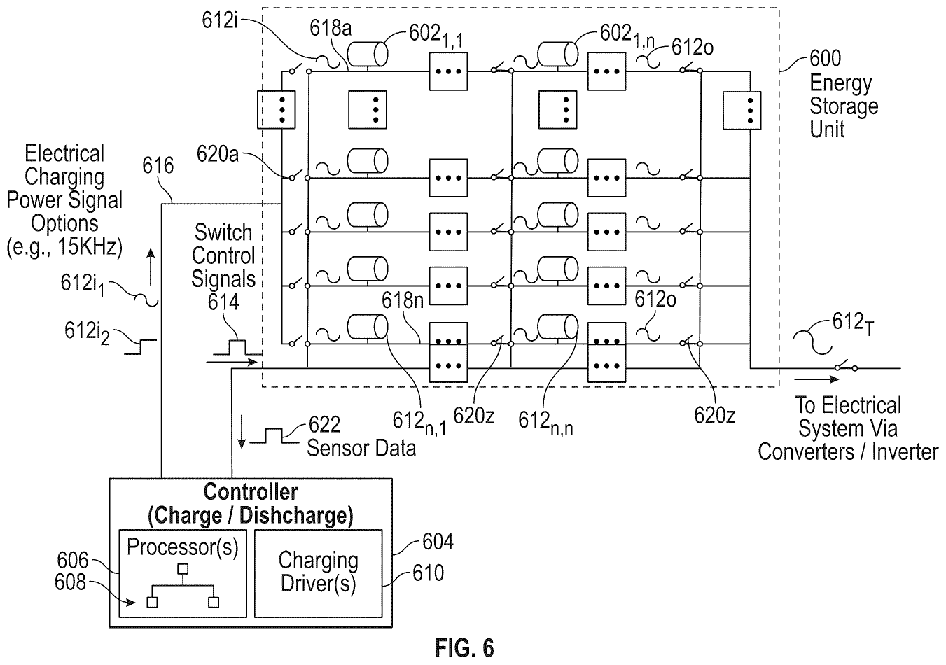

With regard to FIG. 4B-1, an illustration of the energy storage unit 400 showing the kinetic cells 402 supported by a set of structural elements 404x (horizontal), 404y (vertical), and 404z (depth) (collectively structure 404) may be disposed within a housing or walls 406 (FIG. 4A) supported by the structure to enclose the kinetic cells 402 therein is shown. In other words, the kinetic cells 402 may be vertically and/or horizontally aligned, where vertically and/or horizontally aligned is not limited to being axially vertically and/or horizontally aligned. Power and data buses (see FIG. 6) may be included in the energy storage unit 400 to enable electricity to charge and discharge the kinetic cells 402. Charging includes charging from a fully or partially discharged state. Each of the kinetic cells 402 may be mounted to a respective fixture 408 (see FIG. 4C-1) that are configured to engage and/or be supported by the structure 404. Each of the fixtures 408 may also include an electrical connectors 410 that may be plugged into and removed from corresponding electrical connectors (not shown) that may be fixedly mounted to the structural elements, thereby enabling a technician to plug the electrical connectors into one another as the fixtures 408 with the kinetic cells 402 are being slid into or otherwise supported by the structure 404 so as to reduce assembly time. Rather than using individual features 408, the structure 404 may include features that releasably engage the kinetic cells 402. The electrical connector 410 may have electrical conductors (not shown) that connect with the kinetic cell 402_{1,1,1} to conduct electrical power signals and/or data signals (e.g., network address, sensor data, etc.). Although the energy storage unit 400 is shown to be a transportable structure (e.g., a cabinet, such as formed with an internal structure and housing, cabinet on wheels, etc.) within which kinetic cells 402 operate, it should be understood that alternative configurations of an energy storage unit may be provided, including constructed into a physical structure (e.g., wall or panel) of a system, such as a marine vessel, thereby not being independently transportable from the system.

In an embodiment, each of the kinetic cells 402 may be configurable with unique network addresses so each of the kinetic cells 402 may be independently controlled (e.g., charged or discharged). In another embodiment, some or all of the kinetic cells 402 may have common network addresses. For example, groups of the kinetic cells 402 may be commonly accessed without network addresses and accessible turning first switches ON and second switches OFF to apply electrical power to the kinetic cells 402 for charging and then first switches OFF and second switches ON for discharging the kinetic cells 402. In yet another embodiment, electrical switches (see FIG. 6) may be included along a grid of electrical conductors and be used to control electrical power to and from the kinetic cells 402 individually, in groups, or all simultaneously.

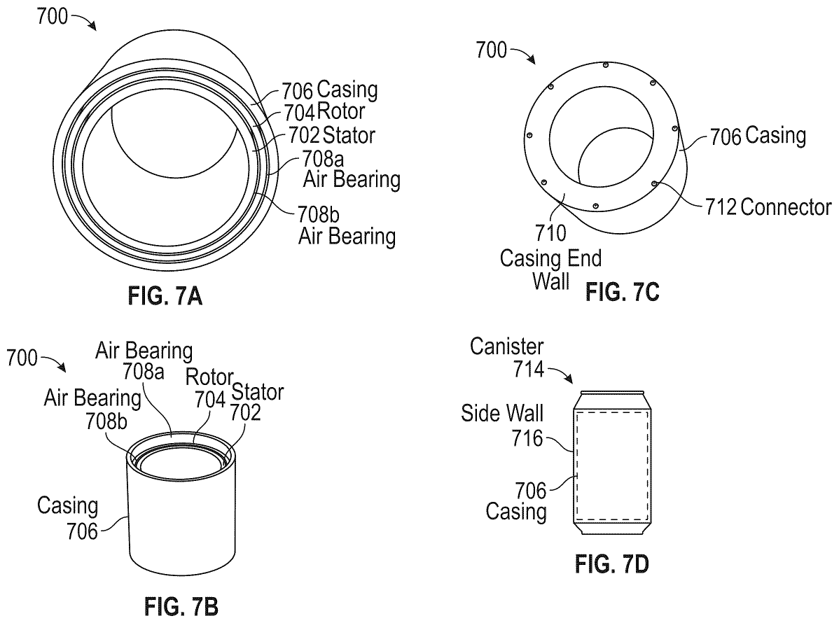

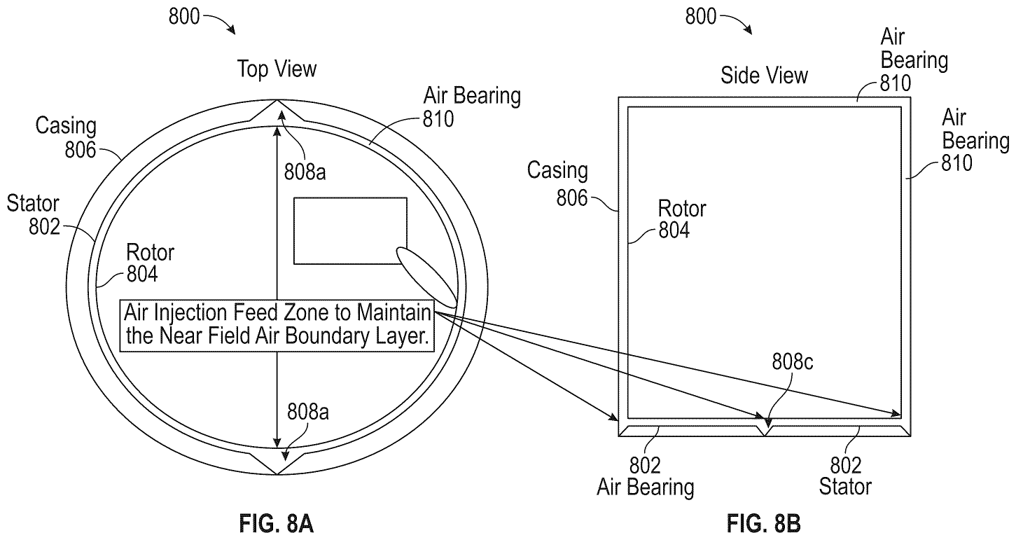

With regard to FIG. 4B-2, an illustration of an alternative illustrative energy storage unit 400′ showing kinetic cells 402′_{1,1,1}-402′_{n,n,n} (collectively 402′) supported by a set of structural elements 404′x (horizontal), 404′y (vertical), and 404′z (depth) (collectively structure 404′) is shown. The structure 404′ may be disposed within the housing or walls 406 (FIG. 4A) supported by the structure 404′ to enclose the kinetic cells 402′ therein. Power and data buses (e.g., grid of electrical conductors) (see FIG. 6) may be included in the energy storage unit 400′ to enable electricity to charge and discharge the kinetic cells 402′. The kinetic cells 402′ in this embodiment are rotated 90-degrees from the kinetic cells 402 of FIG. 4B-1. The horizontal orientation of the kinetic cells 402′ results in a larger dynamic air bearing area on sides of a cylinder (e.g., rotor), thereby resulting in less energy being used to levitate the rotor on a thin air boundary or bearing between rotor and stator (see, for example, FIGS. 7A and 8) as compared to an end of a cylinder (e.g., rotor) being used for levitation thereof.

The energy storage unit 400′ may be configured to support the horizontally oriented kinetic cells 402′, but otherwise configured the same or similar to that of the energy storage unit 400 (FIG. 4B-1) to provide the same or similar functionality thereof. The kinetic cells 402′ may be mounted to fixtures 408′ (see FIG. 4C-2) that are configured to engage and/or be supported by the structure 404. Each fixture 408′ may also include an electrical connector 410′ that may be plugged into and removed from corresponding electrical connectors (not shown) that may be fixedly mounted to the structure 404′, thereby enabling a technician to plug the electrical connectors into one another as the fixtures 408′ with the kinetic cells 402′ are being slid into or otherwise supported by the structure 404′ so as to reduce assembly time. Rather than using individual features 408′, the structure 404′ may include features that releasably engage the kinetic cells 402′.

With regard to FIG. 5, an illustration of an alternative illustrative energy storage unit 500 inclusive of multiple kinetic cells 502a-502n (collectively 502) is shown. In this case, the energy storage unit is two-dimensional and includes a more limited number of kinetic cells 502 (e.g., six kinetic cells). The kinetic cells 502 may be sized and configured to store 250 Wh, 1,000 Wh, 10,000 Wh, or otherwise of electrical energy. As such, the electrical system to which the energy storage unit 500 supplies power may consume significantly less electrical power than a marine vessel, but may be any number of transportation systems (e.g., electric bicycle, scooter, powered skateboard, powered wheelchair, etc.) or electrical storage system available for recharging batteries (e.g., electric vehicle rechargeable batteries).

With regard to FIG. 6, an illustration of an illustrative energy storage unit 600 inclusive of multiple kinetic cells 602_{1,1}-602_{n,n} (collectively 602) along with a controller 604 is shown. The controller 604 may be configured to control charging and discharging of the kinetic cells 602, and may include one or more processors 606 configured to execute software 608 to manage charging of the kinetic cells 602. Each of the processor(s) 606 may execute the same or different software instructions to perform the same or different functions. The controller 604 may also include one or more charging drivers 610 that are configured to condition and output electrical charging power signals 612i₁ that are used to charge the kinetic cells 602 by causing rotors of the kinetic cells 602 to spin (e.g., up to 200 K RPM or higher). In a first embodiment, the input electrical charging power signals 612i₁ may be about alternating current (AC) signals operating at 15 KHz and have a wide range of amplitudes (e.g., 0 to 1,100 volts). Other frequencies, either higher or lower, may be utilized for charging the kinetic cells 602. Still yet, the electrical charging power signals 612i₁ may be variable as controlled by the controller 604. In response to the input electrical charging power signals 612i₁ being applied to the kinetic cell(s) 602, the rotor of the kinetic cell(s) 602 may be initiated to rotate. The charging driver(s) 610 may output alternating electrical signals. Alternatively, the charging drivers 610 may output direct current (DC) power signals as input electrical charging power signals 612i₂ and DC/AC converter(s) (not shown) may be disposed in the energy storage unit 600.

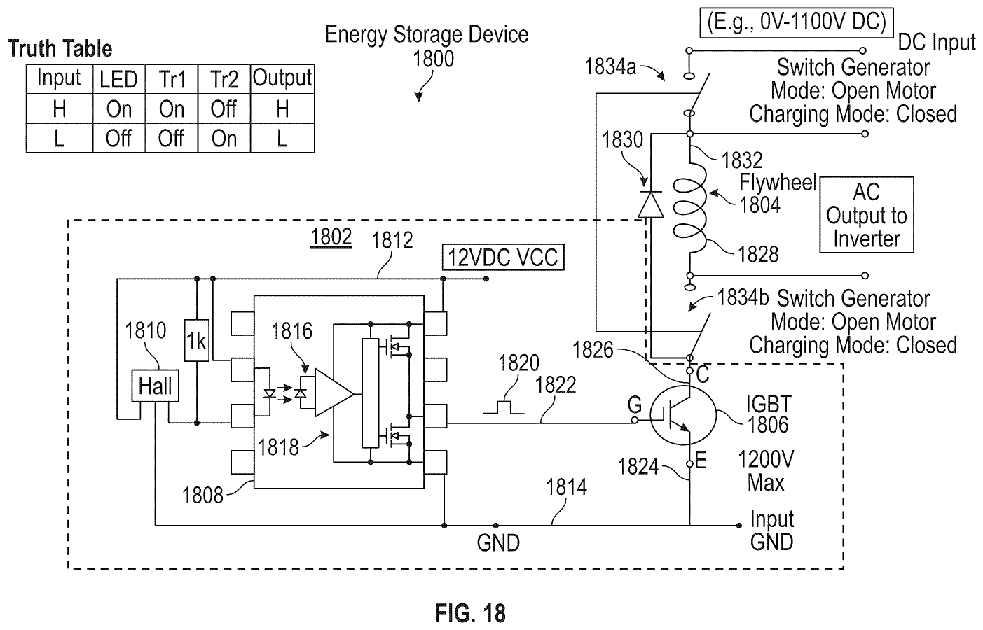

The input electrical charging power signals 612i₂ may range from 5V DC to 1,100V DC or higher depending on driving circuitry of the kinetic cells 602, such as shown in FIG. 18. To significantly reduce or avoid magnetic cross-coupling of the kinetic cells 602, the input electrical charging power signals 612i₂ may be synchronized, thereby causing magnets of the kinetic cells 602 to spin synchronously. In an embodiment, to enable the kinetic cells 602 to spin synchronously, each of the kinetic cells 602 along a row and/or column may be measured for maximum speed. Thereafter, the charging drivers 610 for each of the respective kinetic cells 602 may be configured to drive the kinetic cells 602 to a maximum of the slowest kinetic cells 602 so that the kinetic cells 602 are able to be spun approximately synchronously (i.e., at approximately the same speed). In an embodiment, each of the kinetic cells 602 may be set to 1 RPM and then synchronously increased to a maximum speed. By maintaining rotation of the kinetic cells 602 to be synchronous, magnetic interference between the kinetic cells 602 may be minimized or avoided. It should be understood that the process of synchronizing the kinetic cells may be performed using any of the embodiments of the kinetic cells 602, flywheels 1500, or other energy storage units described herein.

To charge selected kinetic cells 602, switch control signals 614 may be generated by the software 608 being executed by the processor(s) 606 and communicated via electrical conductor 616 to multiple electrical conductors 618a-618n (collectively 618) on which electrical switches 620a-620z (collectively 620) may be arranged. The kinetic cells 602 may be disposed along electrical conductors 618 and arranged relative the switches 620 so that one or more of the kinetic cells 602 may be selectably charged and discharged, as further described herein. In an alternative embodiment, rather than having switches disposed along the electrical conductors 618, switches may be positioned in or with the kinetic cells 602 (e.g., integrated into housings or fixtures of the kinetic cells 602). In an embodiment, a multiplexer (not shown) may be used to apply the switch control signals 614 to selected electrical switches 620 to turn ON and OFF the switches 620. It should be understood that the electrical conductors 618 and switches 620 may be arranged such that entire rows, columns, regions, etc., may be selectably charged and discharged (or kinetic energy maintained), thereby enabling the energy storage unit 600 to be flexibly controlled and efficiently managed. For example, portions of the kinetic cells 602 may be charged and preserved as reserve electrical energy. As another example, some portions of the kinetic cells 602 may be charged while other portions of the kinetic cells 602 are being discharged.

In operation, the switch control signals 614 may be used to turn ON or OFF one or more of the switches 620 to enable charging, discharging, or maintaining charge of the kinetic cells 602. The switch control signals 614 may be digital or analog. If digital, the signals may include network addresses or be used to identify switch(es) to toggle from OFF to ON and vice versa. For example, rather than using network addresses, “crossbar” locations may be utilized (i.e., switches along a 1D, 2D, or 3D grid may be arranged as “crossbar” locations depending on the configuration of the switches 616 and kinetic cells 602). If the kinetic cells 602 are arranged in two-dimensions, then identification of switches in 2D (x,y) coordinates may be made. If the kinetic cells 602 are arranged in three-dimensions (see FIGS. 4B-1 and 4B-2), then identification of switches in 3D (x,y,z) coordinates may be made.

As shown, sensor data 622 may be digital data that is fed back to the controller 604. The sensor data 622 may include sensor information from the kinetic cells 602, such as speed of rotation (e.g., from a zero-spin rate to a maximum spin rate), estimated amount of remaining charge, time since last charge, status (e.g., spinning or not spinning), error code, and so on. In an alternative embodiment, rather than being digital, the sensor data 622 may be analog signals and the controller 604 may convert the analog signals to digital data. The sensor data 622 may also include electrical signals, such as current and/or voltage, measured along one or more of the electrical conductors 618. The sensor data 622 may be used for initial testing (e.g., prior to applying electrical power) and for feedback control during operations. The sensor data 622 may be communicated on the same or different communications channels as the switch control signals 614.

In an embodiment, when some or all of the kinetic cells 602 are at least partially charged (i.e., spinning or rotating), the controller 604 may selectably turn OFF and ON certain switches 620 to conduct electrical signals 6120, which may result in electrical signal 612T being cumulative or total amount of electrical power as discharged by the selected individual kinetic cells 602 (as controlled by setting the switches 620 to respective ON and OFF states). It should be understood that electrical device(s) (e.g., adders or nodes) may be disposed along the electrical conductors 618 to generate the total electrical signal 612T. The total electrical signal 612T may be communicated to an electrical system, such as an electrical system of a marine vessel, automobile, or otherwise, as previously described.

With regard to FIGS. 7A-7C, illustrations of components 700 of an illustrative kinetic cell is shown. The components 700 may include three primary components 700, including a stator 702, rotor 704 and casing 706. As shown, the stator 702 is centrally located between the rotor 704 and casing 706, and each are concentric relative to one another such that the casing 706 surrounds or encircles the rotor 704 and the rotor 704 surrounds the stator 702. Between the stator 702 and rotor 704 is a dynamic air gap bearing or air bearing 708a, and between the stator and casing 706 is another air bearing 708b. The air bearings 708a and 708b may have approximately the same air gap distances when the rotor 704 is rotating. In an embodiment, the gap distances may be less than about 0.7 mm. More particularly, the gap distances may be about 0.5 mm. Other air gap distances are possible depending on dimensions of the components 700. The use of air bearings 708a and 708b causes the air gaps to be substantially constant spacing. The terms “approximately,” “substantially,” and “about” generally refer to mechanical tolerances of manufacturing equipment and/or other processes such that differences of below about 5% may be possible. With 0.5 mm air gap clearance of the gap distances where there is some air in an enclosed chamber (see FIG. 7C) that is drawn around the rotor 704, the rotor 704 is wrapped inside an air bearing “shock absorber” that allows for the rotor 704 to withstand pronounced shocks in all directions without contacting the stator 702 or casing 706. The components 700 may form a donut-shaped structure that encases the rotor 704 in a hollow region for inclusion in a canister (see FIG. 7D).

The predetermined amount of electrical energy may be 250 Wh or higher based on a number of factors, including rate of rotation, configuration of electromagnetics (e.g., materials, spacing, number of windings, etc.), and so on. It should be understood that the dimensions and other electromagnetic characteristics of the components 700 may increase or decrease the amount of electrical energy stored while the rotor 704 is rotating about the stator 702. In an embodiment, the rotor 704 and stator 702 may be formed of steel. In an embodiment, the rotor 704 and/or stator 702 may be formed of another material, and be formed of the same or different materials for performance or other purposes.

The rotor 704 may be a self-levitating Kingsbury or other aerodynamic bearing by configuring at least one feature on the surface(s) (see, for example, FIG. 8) of the rotor 704, stator 702, and/or casing 706 to support self-levitating capabilities of the rotor 704. The air bearings 708a and 708b may be cylindrical bushing air bearings. If the shape of the stator 702, rotor 704, and casing 706 were different, then other air bearings with different configurations that perform the same or similar function may be utilized. The feature(s) of the surface(s) of the rotor 704, stator 702, and/or casing 706 may cause a velocity-induced pressure gradient to be formed and increase as the speed of the rotor 704 increases. The increased pressure between the surfaces creates a load carrying effect. At zero speed, the rotor 704 and stator 702 contact one another, and the stator 702 and casing 706 contact one another. When the rotor 704 rotates, however, the feature(s) of the surfaces cause air bearings 708a and 708b (collectively 708) to maintain spacing between the stator 702 and rotor 704, and rotor 704 and casing 706. Moreover, the rotor 704 levitates (and remains centrally positioned) as a result of another air bearing (not shown) being formed between the rotor 704 and end walls that are formed between the casing 706 and stator 702. Although not shown, the surfaces of the stator 702 and/or rotor 704 may have features, such as nano-gradient features, that may enable air resistance to be lowered or rotation speeds to be increased. For example, if surface area of the rotor 704 is reduced, then increased speeds with lower resistance may result. Moreover, the shape 704 and configuration of the rotor 704 may be varied to further provide increased speed, increased (or decreased) inertial mass, and/or otherwise to provide for optimized energy storage based on the size and configuration of the kinetic cell.

With regard to FIG. 7B, an illustration of components 700 including the stator 702, rotor 704, and casing 706 with the respective air bearings 708 is shown. In an embodiment, the height and diameter of the casing 706 may be approximately 10 cm (3.93-inches). The height of the stator 702 and rotor 704 are shorter than the casing 706 such that the stator 704 and rotor 704 may be positioned therein with sufficient clearances for end walls (see FIG. 7C) to be connected to the casing 706 and magnets and coils to be affixed to the stator 702 and rotor 704. It should be understood that alternative dimensions of the casing 706 may be utilized depending on the mechanical and electromagnetic characteristics of the kinetic cell 700.

With regard to FIG. 7C, an end perspective view of the casing including a casing end wall 710 attached to the casing 706 using connectors 712, such as bolts, that are equally spaced along the diameter of the end wall 710, thereby forming a closed, limited passive air chamber in which the rotor 704 is rotated when in operation is shown. Other techniques, such as welding, may be utilized to secure the casing end wall 710 to the casing 706. In addition to providing for a closed, limited passive air chamber, the casing 706 provides safety for people and equipment in proximity of an energy storage unit in which the kinetic cell 700 is operating. The casing 706 may be formed of a number of different materials, including stainless steel, aluminum alloy, carbon fiber, or otherwise.

With regard to FIG. 7D, an illustration of an illustrative canister 714 in which components 700 including the stator 702, rotor 704, and casing 706 of FIGS. 7A-7C operate is shown. The canister 714 is configured to prevent the contents therein from exiting in the event of a catastrophic failure during operation to avoid damage to other equipment or injury to people. The canister 714 is independent of the casing 706, and may be formed of Kevlar, such as the Kevlar® EXO™ produced by DuPont. Kevlar EXO is 30%-40% stronger than conventional Kevlar. Other materials that provide similar or stronger resistance to breaking (e.g., being punctured, tearing, etc.) may be utilized. In an embodiment, the canister 714 may be fixedly attached (e.g., bonded, fused, etc.) or otherwise connected to the casing 706. In any embodiment, the canister 714 may enclose the casing 706 such that the component(s) 700 of the kinetic cell do not escape the canister 714. Alternatively, the canister 714 and casing 706 may remain independent from one another. That is, based on an amount of kinetic energy of the rotor 704 when operating at maximum rotational speed (e.g., 250K RPM, 500K RPM, 1M RPM, etc.) materials that can contain such energy in the event of catastrophic failure may be utilized in forming the canister 714. In an alternative embodiment, the canister 714 may be formed of multiple layers of Kevlar EXO or other material. If multiple layers are utilized, then the material may be conventional Kevlar or similarly strong or stronger material that avoids failure in the event of the rotor 704 escaping from the casing 706. Still yet, structural features, such as a truss or corrugation structure, between layers of the canister 714 may be utilized to add strength.

The canister 714 may be attached to and surround the outer casing 706, thereby preventing rotation of the casing 706 with respect to the canister 714 and providing added protection in the event of a catastrophic malfunction of the components 700. In an embodiment, the internal atmospheric pressure may be one atmosphere (1 ATM). Alternative atmospheric pressures may be possible. The canister 714, therefore, may be configured to provide 40 Kilo pounds-per-square-inch (KSI), thereby ensuring utmost protection given the rates of speed of the rotor 704. It should be understood that the strength of the canister 714 may vary depending on a number of functional and utilization criteria. For example, rather than providing about 40 KSI protection from damage, the canister 714 may provide 10 KSI to 100 KSI or more protection. If, for example, the size of the stator 702, rotor 704, and casing 706 increase, then the size and strength of the canister 714 may also increase. As shown, a sidewall 716 may have a length of about 4.8-inches (about 12.2 cm) and diameter of the canister 714 may be about 2.6-inches (about 6.62 cm). It should be understood that alternative dimensions and configurations of the canister 714 may be utilized in accordance with the principles described herein. The canister 714 may have tapered portions 718a and 718b (collectively 718) at the top and bottom, but alternative shapes may be utilized. In an embodiment, a fixture, such as fixture 408 of FIG. 4C-2, may be mounted to or connected to the canister 714 for mounting within a structure, such as structure 404. The canister 714 may include an electrical connector (not shown) that extends therethrough so that electrical signals to charge and discharge the rotor may be provided.

With regard to FIGS. 8A and 8B, respective top view and side view illustrations of a portion of an illustrative kinetic cell 800 including a rotor 804 and casing 806 is shown. In this configuration, the stator 802 is not shown, but is concentric with an contained within the rotor 804. The casing 806 may include air injection feed zones 808a and 808b (collectively 808) to maintain a near-field air boundary layer between the casing 806 and rotor 804. The air injection feed zones 808 are shown as triangular protrusions extending from an inside wall 809a towards an outside wall 809b of the casing 806. It should be understood that alternatively shaped and different numbers of air injection feed zones 808 may be utilized. In operation, air positioned in the air injection feed zones 808 may be drawn into an aerodynamic air bearing or thin air boundary 810 when the rotor 804 spins within the casing 806.

As shown in FIG. 8B, another air injection feed zone 808c disposed in a bottom wall 812 of the casing 806, thereby causing air disposed within the air injection feed zone 808c to support the rotor 804 along an end from the casing 806. More or fewer air injection feed zones may be defined by the casing 806 so as to provide sufficient air to form the thin air boundary 810 when the rotor 804 rotates. It should be understood that the kinetic cell 800 may be rotated 90 degrees such that the side wall of the rotor 804 is horizontally aligned (i.e., center axis is horizontal).

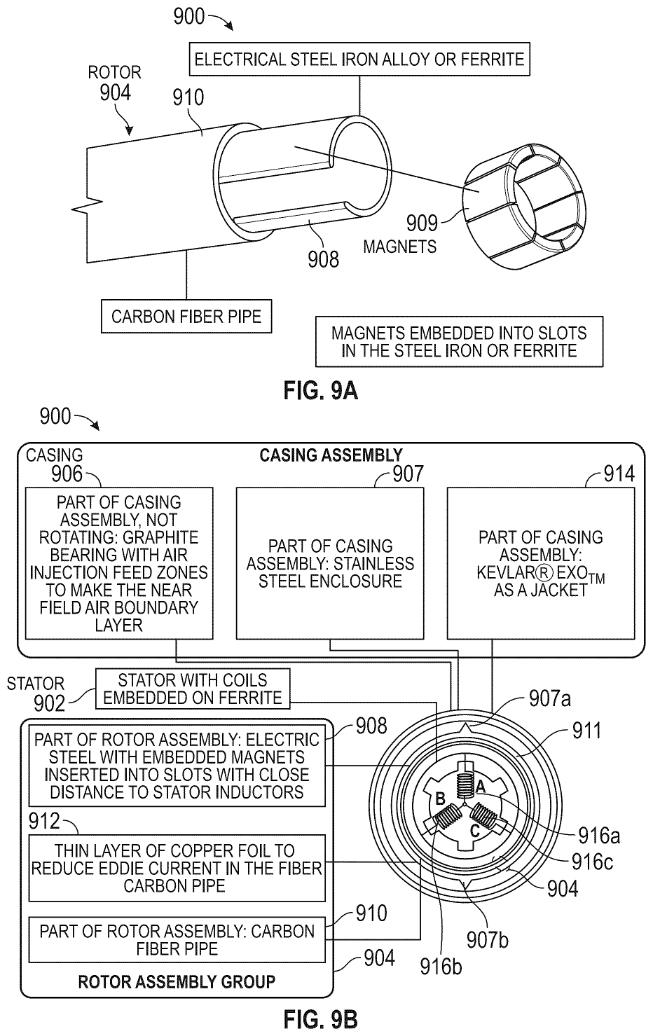

With regard to FIGS. 9A and 9B, illustrations of an illustrative kinetic cell 900 including a rotor assembly or rotor 904 is shown. The rotor 904 may include multiple components, including (i) a first tubular component 908 with magnets 909 integrated therewith and (ii) a second tubular component 910 that encircles the first tubular component 908. The first tubular component 908 may be formed of electrical steel iron alloy or ferrite or other comparable material. The second tubular component 910 may be formed of carbon fiber or other comparable material. In an embodiment, the inside of the second tubular component 910 may be covered or coated with a thin layer of copper foil or comparable material 912 having a thickness of about 0.6 mm (+/−0.2 mm) so as to minimize eddy currents that may otherwise form in the second tubular component 910. Magnets 909 may be embedded into slots in the steel iron alloy or ferrite of the rotor. The magnets 909 may be one pole magnet pairs and may cover 180°. Each of the one-pole magnet pairs may be embedded in the rotor 904 at closest proximity to inductors in the stator 902.

With regard to FIG. 9B, an illustration of a more detailed view of the kinetic cell 900 inclusive of a stator assembly or stator 902, rotor 904, and casing assembly or casing 906 is shown. As understood, the stator 902 is maintained in a fixed position (i.e., does not rotate) relative to the casing 906. In an embodiment, the stator 902 and casing 906 may be connected directly or indirectly (e.g., via a casing end wall, such as casing end wall 710 of FIG. 7C). The stator 902 may include coils 916a-916c (collectively 916) that may be embedded on ferrite (see FIG. 11).

The rotor 904 includes the first tubular component 908 formed of electrical steel with embedded magnets 909 inserted into slots with close distance to stator inductors or coils 916. The rotor 904 includes a second tubular component 910 and a thin layer of copper foil 912 to reduce eddy current in the second tubular component 910 formed of carbon fiber or other similar material.

The casing 906 does not rotate and may have an inner layer formed of graphite or other material that is in air-relation with an air bearing 911. The casing 906 may include feed zones 907a and 907b (collectively 907) that maintain air that is used to create a near-field air boundary layer in the air bearing 911 when the rotor 904 is rotating. The size and number of feed zones 907 may be defined by the air bearing 911. The casing may further include a portion of stainless-steel enclosure that provides for strength of the casing. On the outside of the casing 906, a canister 914, which may form part of the casing 906 or be independent thereof may be used. The canister 914 may be formed of Kevlar EXO, and be considered a “jacket” to the casing 906. The canister 914 is meant to prevent the rotor 904 or any portion thereof from exiting the kinetic cell 900.

The ferrite inside the coils provides high magnetic permeability in combination with low electrical conductivity to reduce eddy currents in the ferrite cores. The kinetic cell 900 may include ferrite inside coils 916 to enhance flux density and reduce eddy currents. In this embodiment, a stator (not shown) may be disposed within the rotor 904 such that the rotor 904 spins between the casing 906 and the stator.

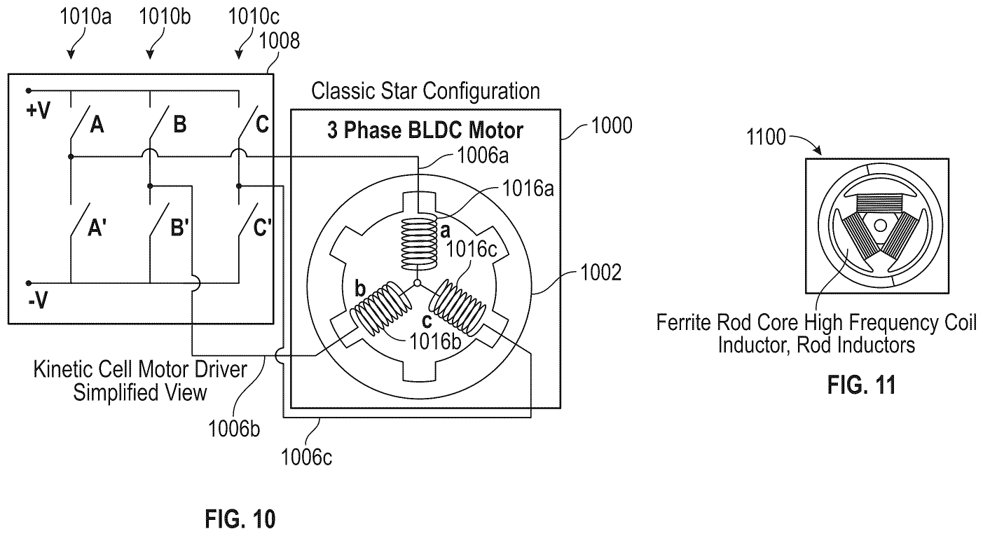

With regard to FIGS. 10A and 10B, illustrations of a 3-phase brushless DC motor 1000 of a kinetic cell inclusive of a simplified view of a motor driver are shown. The brushless DC motor 1000 includes a stator 1002 and coils 1004a-1004c (collectively 1004) with a classic star configuration. Electrical conductors 1006a-1006c (collectively 1006) may be electrically connected to a motor driver 1008 with switches 1010A, 1010A′, 1010B, 1010B′, 1010C, 1010C′.

As understood, to cause the rotor of the kinetic cell to rotate, signals are applied to the coils by the motor driver 1008, as provided in TABLE I. In an embodiment, a 15 KHz signal may be applied to the coils to charge or spin up the rotor (e.g., up to or higher than 250K RPM), thereby creating and storing kinetic energy by the rotor. While the rotor is charged, when magnets of the rotor (see, for example, rotor 904 of FIG. 9) are electromagnetically coupled to the coils 1004, an electric current is induced, which simultaneously causes the kinetic cell to discharge (i.e., reduce kinetic energy and slow down).

TABLE I
Kinetic Cell Motor Driver

Switching Sequence AA′ BB′ CC′

| Position (θ) | Sector | AA′ | BB′ | CC′ |
|---|---|---|---|---|
| (−30°, 30°] | 1 | 00 | 10 | 01 |
| (30°, 90°] | 2 | 01 | 10 | 00 |
| (90°, 150°] | 3 | 01 | 00 | 10 |
| (150°, 210°] | 4 | 00 | 01 | 10 |
| (210°, 270°] | 5 | 10 | 01 | 00 |
| (270°, 330°] | 6 | 10 | 00 | 01 |

With regard to FIG. 11, an illustration of an illustrative ferrite rod core high-frequency coil inductor and rod inductors 1100 is shown. The arrangement may be used as part of the brushless DC motor.

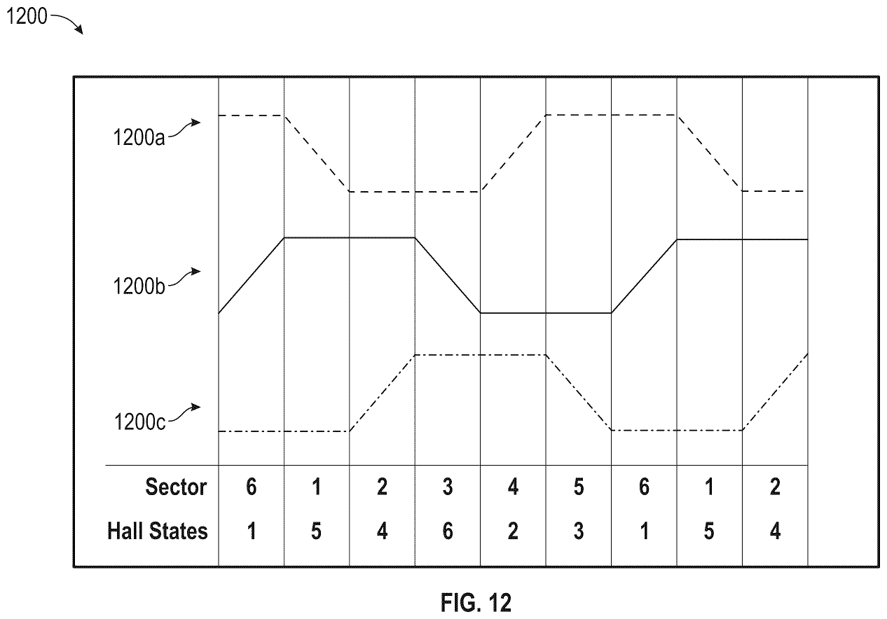

With regard to FIG. 12, an illustration of an illustrative graph inclusive of a set of signals 1200a-1200c (collectively 1200) that are used to charge and discharge a kinetic energy cell is shown. The signals 1200 follow the switching sequence described in TABLE I.

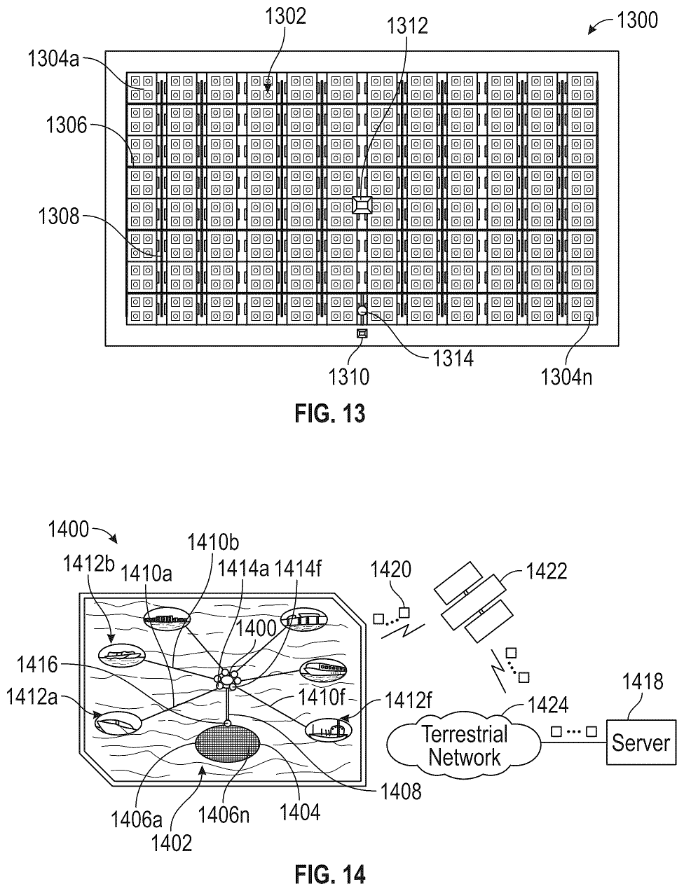

With regard to FIG. 13, an illustration of an illustrative barge 1300 on which an electrical power system 1302 inclusive of energy storage units 1304 inclusive of kinetic cells for use in storing kinetic energy and distributing electrical power therefrom is shown. The barge 1300 is a passive barge and may contain one or more electrical power systems configured with many energy storage units 1304 to supply power to other marine vessels or onshore power systems directly or indirectly (e.g., via a charging station or charging buoy). In an alternative embodiment, the barge 1300 may be an active barge (i.e., include a propulsion system) or be any other type of marine ship or vessel that is propelled through water (e.g., ocean, river, or any other body of water). As shown, the electrical power system or power network 1302 may include energy storage units 1304 (generally operated in pairs), electrical conductors 1306, and electrical switches 1308 along the conductors 1306 of the electrical power system 1302 that enables an operator to switch electrical power ON and OFF from being conducted to or from one or more of the energy storage units 1304, thereby controlling recharging of and sourcing from the energy storage units 1304 on the electrical power system 1302.

A computing system (not shown) may be used to control operation of the switches 1308 and energy storage units 1304 on the electrical power system 1302. A smart metering system (not shown) including electrical meters (e.g., smart meters) may be configured to monitor amount of time, electrical power, or otherwise that is transferred to and from the electrical power system 1302 and/or individual energy storage units 1304. A computing system may interface with the smart meters to track customers of the electrical power system 1302 and generate information for billing of the customers, where the customers may be marine vessels, land customers, marine platforms, or otherwise.

As further shown, an electrical connector 1310 may be in electrical communication with one or more of the electrical conductors 1306 to enable another electrical connector (not shown) of an electrical conductor (not shown) that connects directly to another marine vessel, for example, a charging buoy, or any other power distributor. The electrical conductors 1306 and switches 1308 may be configured as an electrical network, such as an electrical grid, and a controller 1312 may be configured to control the switches 1308 to cause electrical power to be output by the energy storage units 1304 and onto the electrical network to flow to the electrical connector 810 to supply power from the barge 1300. The controller 1312 may be configured to cause electrical power to flow from the energy storage units 1304 to the electrical power system 1302 without disrupting available electrical power being supplied by the electrical power system 1302. In an embodiment, the controller 1312 ensures that another set of energy storage units are connected prior to disengaging power from the connector 1310.

In an embodiment, a smart meter 1314 may be configured to measure electrical power drawn from the connector 1310, time of power draw by another electrical power system (e.g., on a marine vessel), and identifier of the other electrical power system. The collected data by the smart meter 1314 may be communicated to a system, such as a remote server, for processing and invoicing thereby. Alternative devices and processes for performing manual, semi-automatic, and automatic data collection and invoicing may be utilized, as well. In an embodiment, a timer of the smart meter 1314 or elsewhere may be utilized to time a duration of power draw by the other electrical power system, and that time may be used as part of an invoice as part of or in addition to the power draw. Moreover, rather than simply measuring time of power draw, an amount of time that the other electrical power system is connected to the electrical connector 1310 may be collected and treated as a separate charge or part of the charge of the electrical draw. If the barge 1300 is an active barge or marine vessel, then the power drawn from the energy storage units 1304 may be used to supply electrical power to electrical equipment and electrical propulsion device(s) and system(s).

With regard to FIG. 14, an illustration of an illustrative charging buoy 1400 that may be connected to an electrical power generation system 1402, such as on a marine platform 1404, inclusive of energy storage units 1406a-1406n (collectively 1406) via an electrical conductor 1408 and be electrically connected to multiple electrical conductors 1410a-1410f (collectively 1410) that may be simultaneously connected in parallel to marine vessels and/or other systems 1412a-1412f (collectively 1412) that use electrical power for supplying electrical power to electrical systems (e.g., ship control systems, radar systems, electrical propulsion systems, etc.) and/or recharging rechargeable batteries thereon is shown. The marine platform 1404 may be stationary on a platform, moored, or moveable so that the energy storage units 1406 stored thereon may be recharged with kinetic energy. In an embodiment, a diesel or other electrical power generation system may be used to recharge the energy storage units 1406. Alternatively, “green energy” electrical power generators, such as solar panels or wind turbines, may be used to recharge the energy storage units 1406. Combinations of power systems may alternatively be positioned on or electrically connected to the electrical power system 1402 to recharge the energy storage units 1406. Still yet, electrical power from a land-based electrical power generator may be electrically connected to the electrical power system 1402 as a backup to “green energy” electrical generators.

As further shown, multiple smart meters 1414a-1414f (collectively 1414) may be disposed at the charging buoy 1400. The smart meters 1414 may be configured to measure electrical power usage by respective marine vessels and/or other systems 1412 when connected to and receiving electrical power from the respective electrical conductors 1410. In addition to the smart meters 1414, a smart meter 1416 may be positioned at the marine platform 1404 and be configured to measure electrical power drawn therethrough from the energy storage units 1406 by the marine vessels and/or other systems 1412. The smart meters 1414 and/or 1416 may be configured to measure and collect various parameters, including electrical power usage, amount of time the marine vessels and/or other systems 1412 are drawing electrical power from the charging buoy 1400, identifiers of the marine vessels and/or other systems 1412, and so on such that a remote server 1418 may process the data for billing owners or operators of the marine vessels and/or other systems 1412 or other purpose. As shown, the smart meters 1414 may be configured to communicate measured and/or collected data and communicate that data 1420 via a satellite 1422 for relay via a terrestrial network 1424, such as the Internet, to the server 1418 for processing. The identifiers of the marine vessels and/or other systems 1412 may be collected in a number of ways, such as wirelessly (e.g., remotely sensed or communicated from the marine vessels and/or other systems 1412 prior to the electrical power being turned ON), manually (e.g., entered into the respective smart meter), or otherwise.

The server 1418 may further be configured to provide management functionality for the marine platform 1404 and energy storage units 1406 either independently or in conjunction with a monitoring system (not shown), such as a local controller, on the marine platform 1404. The management functionality may include monitoring charge status of each of the energy storage units 1406. As the kinetic energy and, consequently, potential electrical power, of the energy storage units 1406 depletes naturally or through supplying power to another electrical system, the server 1418 may be configured to monitor and identify the change and current status of the energy storage units 1406. Prediction software may be utilized to predict an amount of time remaining for each of or a collective number of the energy storage units 1406. The server 1418 may provide a notification to an operator of an estimated time that a new marine platform (e.g., power station barge) is needed to replace the existing marine platform 1404 so that electrical power supply is not disrupted. Alternatively, rather than sending a new marine platform with energy storage units 1406, a charging system may be sent to the marine platform 1404 to recharge the kinetic cells of the energy storage units 1406. Alternative ways of charging the energy storage units 1406 may be utilized. The estimation of remaining time may be dependent on a number of factors, including, but not limited to, scheduling of marine vessels or other systems that are to be powered by the energy storage units 1406 of the marine platform 1404. In an embodiment, the energy storage units 1406 may be charged using off-shore wind turbine(s) or other non-carbon producing system or carbon-producing system that is local or remote from the energy storage units 1406.

### Single Phase Flywheel Design

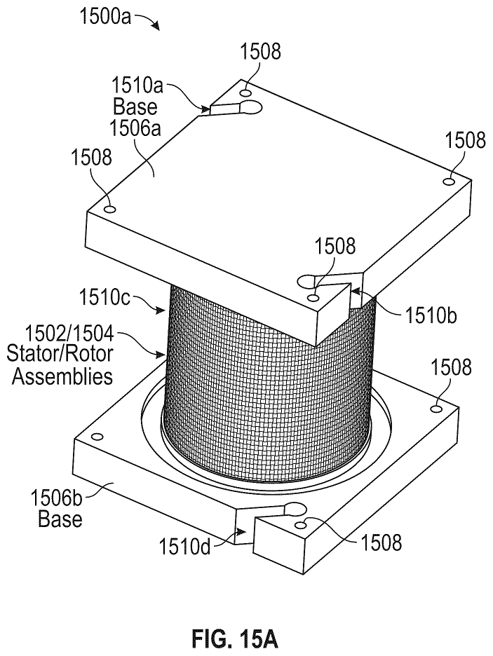

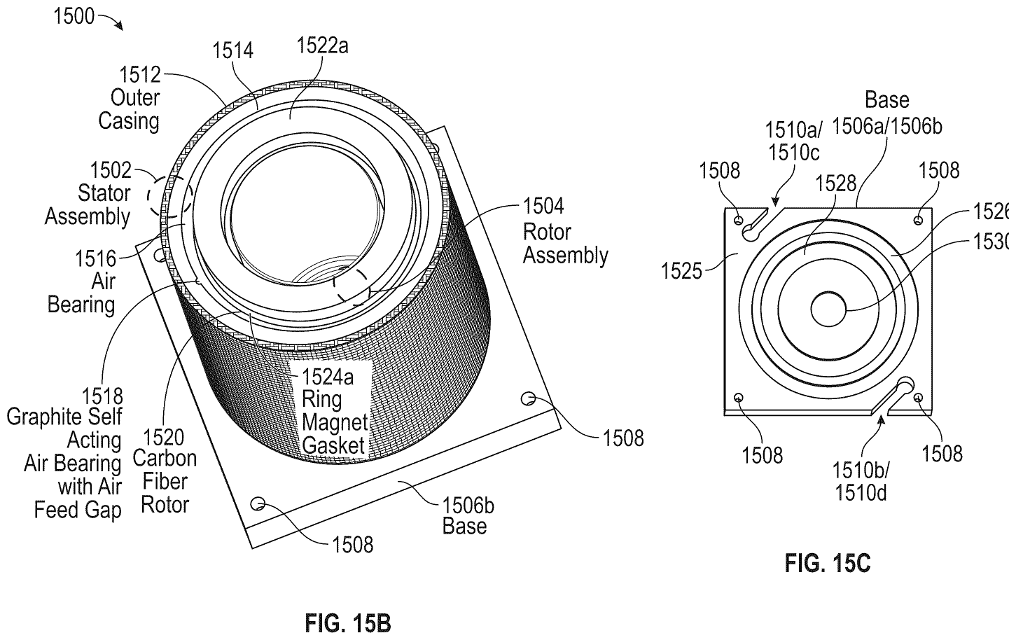

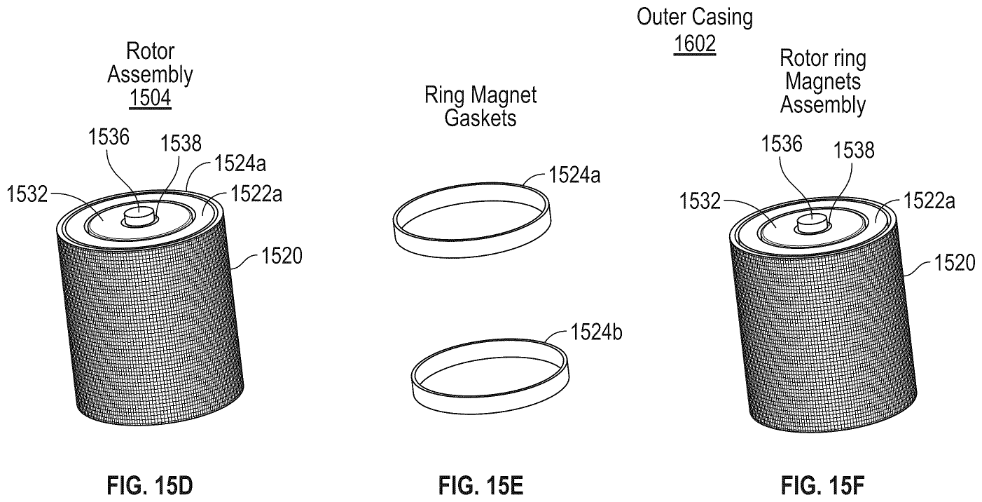

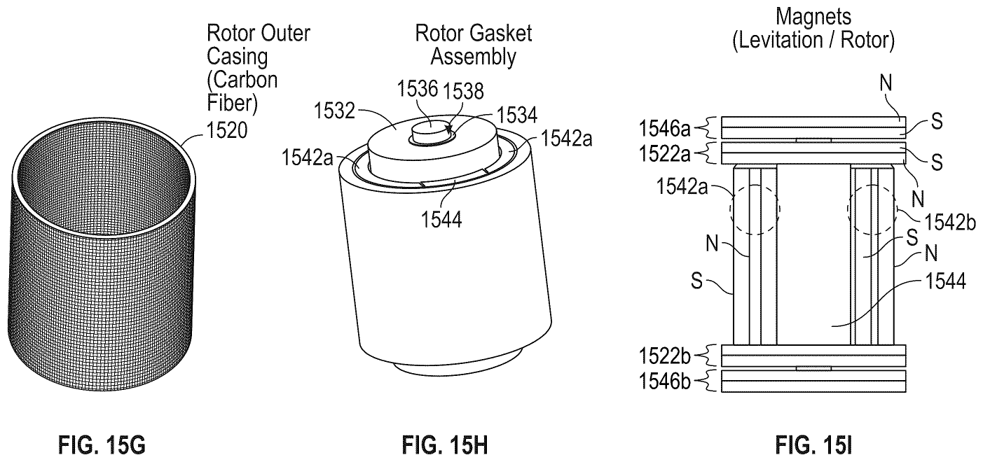

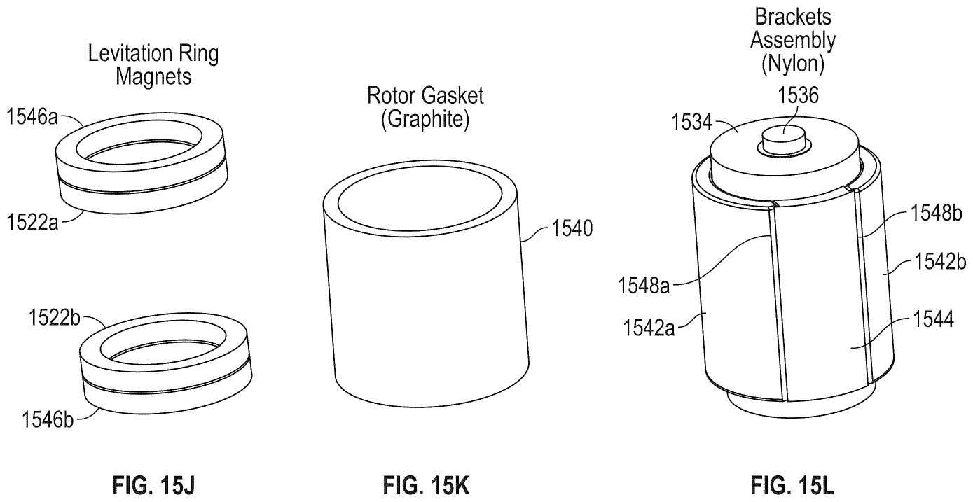

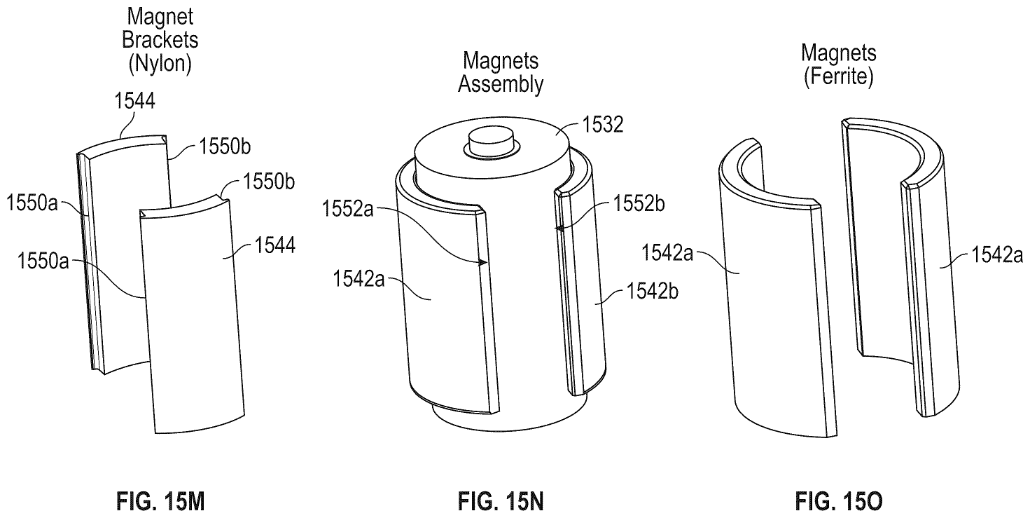

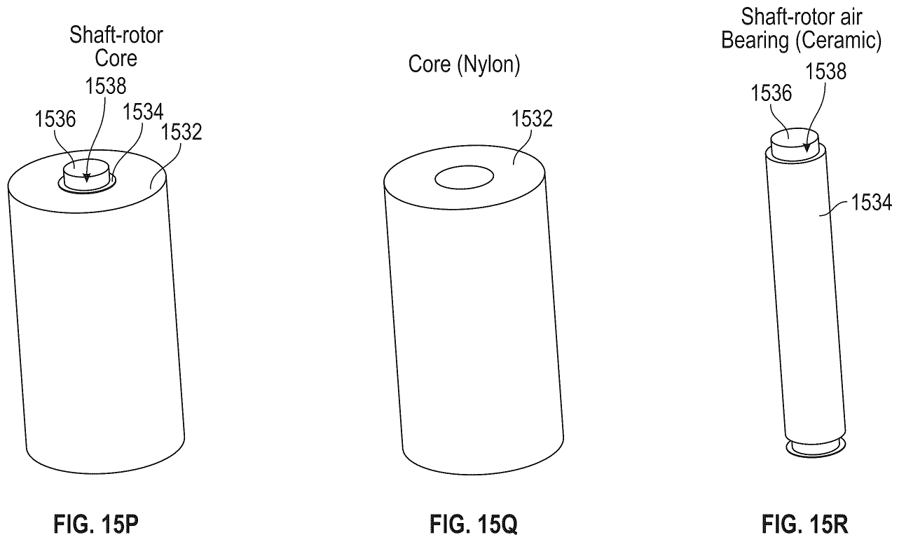

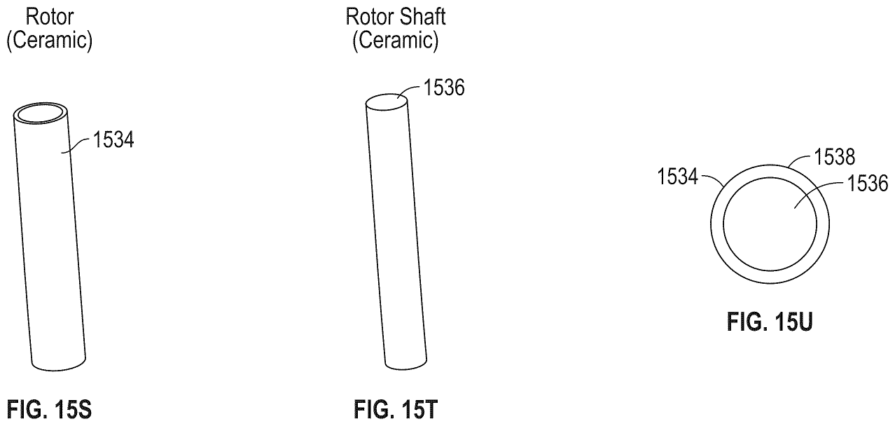

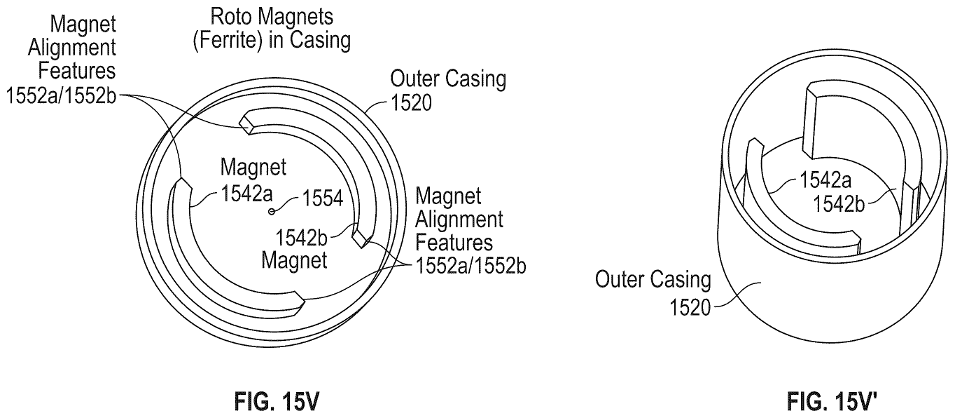

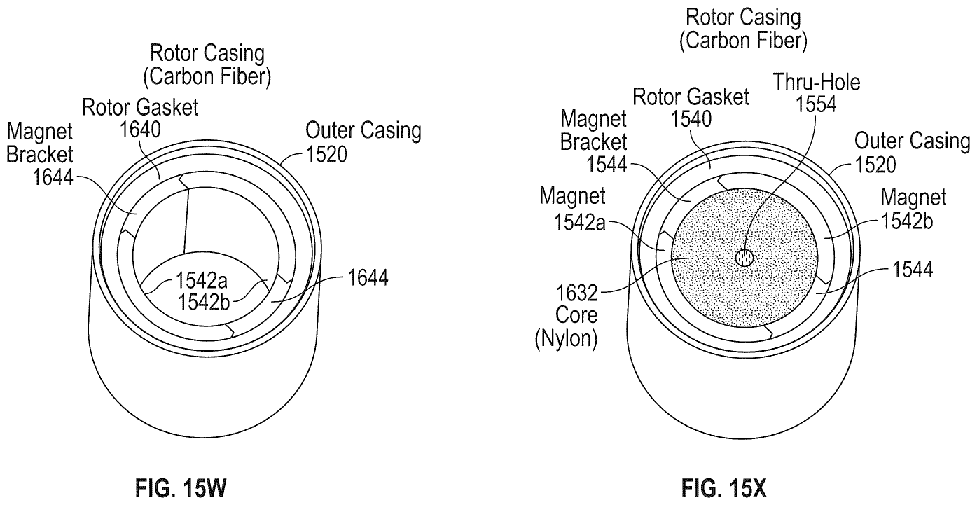

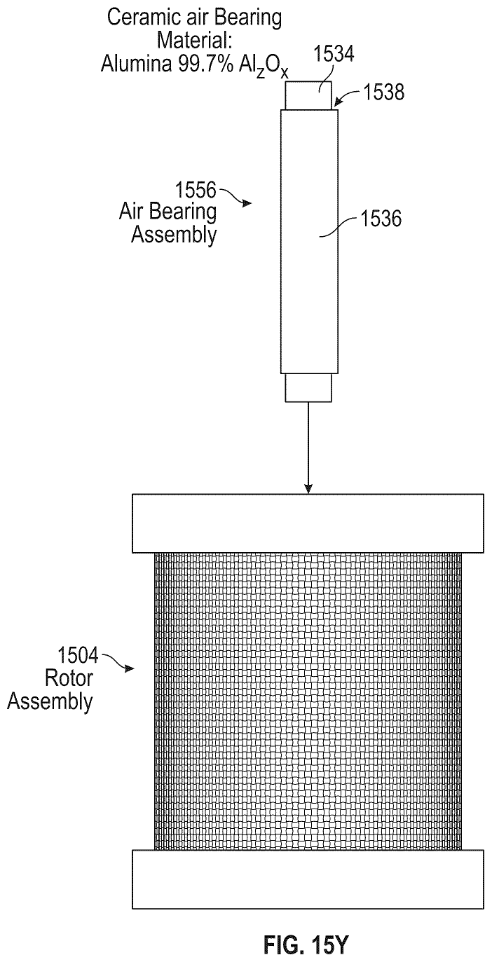

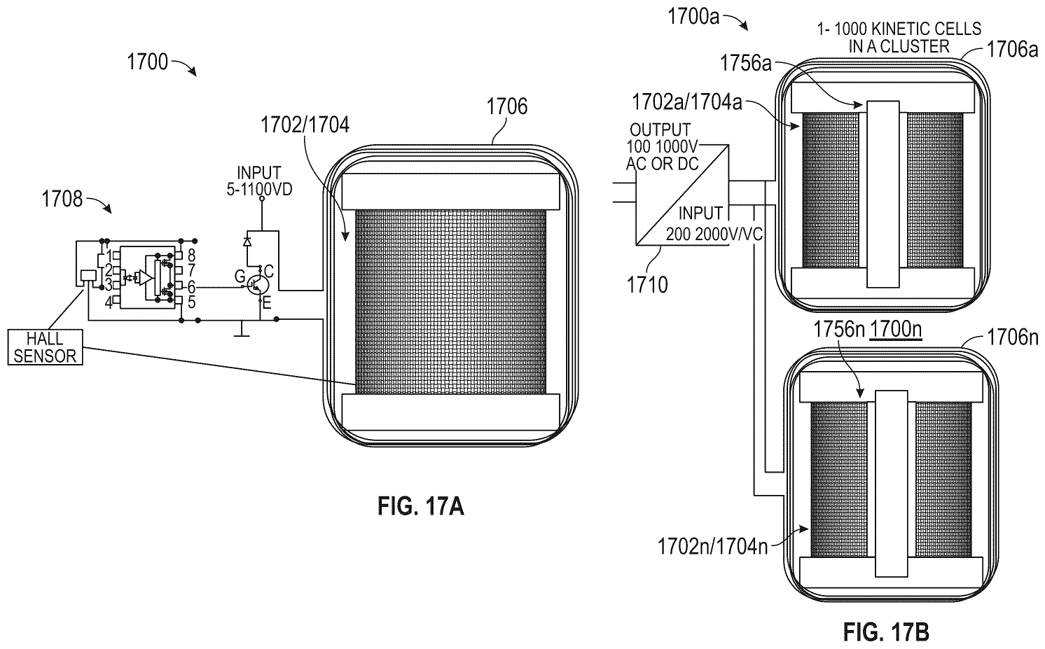

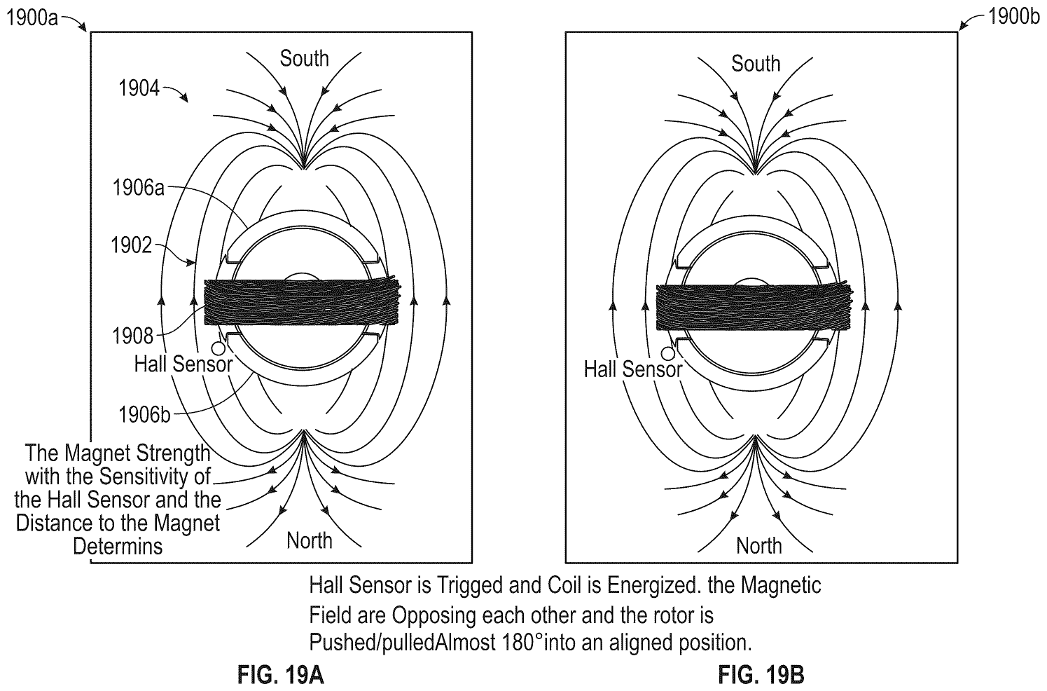

With regard to FIGS. 15A-15Y, illustrations of an illustrative alternative flywheel 1500 and components thereof are shown. In this embodiment of the flywheel 1500, other than coils used as generator/motor windings, no materials that are reactive to magnetic fields may be included and a rotor assembly may be contactless, as further described herein. The flywheel 1500 is an illustration of a fully assembled flywheel, albeit without showing generator/motor windings (see, for example, FIGS. 17A, 19A, and 19B). By way of contrast, the flywheel 1500 has a different configuration than the flywheel 900 of FIGS. 9A and 9B in that the flywheel 1500 is configured as a single-phase generator/motor, as further described with regard to FIGS. 15C-15Y, as opposed to a three-phase generator/motor (see, for example, FIG. 10), as further described hereinbelow. The flywheel 1500 includes stator/rotor assemblies 1502/1504, bases 1506a and 1506b (collectively 1506), mounting openings 1508 in each corner defined by the bases, winding slots 1510a-1510d (collectively 1510) for use in enabling generator/motor windings to be positioned therein. Not shown may include a protective housing that may be formed of a material, such as Kevlar®, to prevent the rotor 1504 from failing and exiting the flywheel 1500 to potentially causing injury to equipment and/or humans.

With regard to FIG. 15B, an illustration of the flywheel 1500 may include a stator assembly or stator 1502 positioned radially outside of a rotor assembly or rotor 1504. The flywheel 1500 with the stator 1502 radially surrounding the rotor 1504 is opposite that of the flywheel 900 of FIG. 9B in which the stator 902 is positioned radially within the rotor 904.

The stator 1502 may include (i) an outer casing 1512 formed by material, such as carbon fiber, which is non-reactive to magnetic fields, and in the shape of a tube. An outer structure 1514 may be formed by graphite with a diameter that radially fits within the outer casing 1512, and be used to define an outer wall of an air bearing 1516. As understood in the art, neither carbon fiber nor graphite form eddy currents within magnetic fields (i.e., non-reactive to magnetic fields or eddy currents formed thereby), thereby avoiding negatively impacting rotation of the rotor 1504 while spinning. In an embodiment, the outer structure 1514 may define a feed gap 1518 to enable air for the air bearing 1516 to be stored and drawn into the air bearing 1516 when the rotor 1504 spins. It should be understood that alternative materials that enable the components to perform the same or similar functions may be utilized.

The rotor 1504 may include an outer casing 1520 that may be formed of carbon fiber that may define an inner structure of the air bearing 1516. The rotor 1504 may include permanent magnets (see, for example, FIGS. 15N and 15O) that are secured in a non-metallic filling material (see, for example, FIGS. 15L and 15M), such as nylon, to retain the permanent magnets in place. The rotor 1504 may further include levitation magnets, such as 1522a (see, also, FIGS. 151 and 15J). It should be understood that the materials of the rotor 1504 may be non-reactive and non-conductive to magnetic and/or electrical fields of the stator 1502 and rotor 1504, and are illustrative such that alternative materials that enable the components to perform the same or similar functions may be utilized, as well. In general, the materials of the flywheel 1500 avoid the use of iron or other metallic materials that are reactive to magnetic fields to avoid impacting the rotor 1504 while in operation.

In one embodiment, the air bearing 1516 disposed between the stator 1502 and rotor 1504 may be about 0.1 mm with an inner diameter (ID) and outer diameter (OD) tolerance of less than about 0.03 mm as it has been determined that inner diameter and outer diameter tolerances of between about 0.05 mm and about 0.1 mm create too much resistance during operation of the rotor 1504. In an embodiment, a length of the rotor 1504 may be the same as a diameter of the rotor 1504 (i.e., L=πr2) to avoid a gyro effect or forces that resist angular rotation of the flywheel 1500. The term “about” means to be within +/−10%. In an embodiment, the feed gap 1518, if included as part of the air bearing 1516, may extend diagonally, as opposed to longitudinally, along the wall of the outer structure 1514 of the air bearing 1516, as a diagonal feed gap 1518 has been found to significantly reduce or avoid creating a periodic “speed bump” during rotation of the rotor. The feed gap 1518 may, in an embodiment, be in the shape of an inverted trapezoid (e.g., 2 mm opening at the surface with 1 mm width at a depth of 1 mm with V-shaped angular walls). Alternative shapes and dimensions may be utilized, as well, to provide the same or similar functions as the feed gap 1518. In another embodiment, the air bearing 1516 does not include the feed gap 1518 (or any other feed gap), but rather utilizes the small space of the air bearing 1516 and highly polished surfaces of the outer structure 1514 and outer casing 1520 to operate efficiently enough to avoid the use of the air bearing 1516. The base 1506b is shown without winding slots 1510 of FIG. 15A. In such a configuration, the generator/motor windings would be wrapped around the base 1506b as opposed to passing through the winding slots 1510 (or an opening defined by the base 1506b).

With regard to FIG. 15C, an illustration of an illustrative base 1506a/1506b (collectively 1506) is shown. The bases 1506 may have identical configurations, thereby enabling structures to extend between the identical features when the bases 1506 are opposing one another. An inside surface 1525 is shown to include a number of features, including a first groove 1514, a second groove 1516, and a third groove 1518. The first groove 1514 may be configured to enable the stator 1504 having a circular profile be fit therein, in one embodiment, frictionally fit. The second groove 1516 may be configured to enable a ring magnet (see, for example, FIG. 15J) to be fit therein, in one embodiment, frictionally fit. The third groove or indentation 1518 may be configured to enable a rotor shaft (see, for example, FIGS. 15R and 15T) to be fit therein, in one embodiment, frictionally fit. Each of the components that are frictionally fit into the respective first, second, and third grooves 1514, 1516, and 1518 may be secured therein by using a glue or other adhesive. Alternative techniques to secure the stator/rotor assemblies 1502/1504 may be utilized.

The bases 1506 may define openings 1508 that may be used to enable fastening members (e.g., screws, bolts, etc.) to secure the bases 1506 to a structure and/or one another when the bases 1506 are secured to the stator 1502 and rotor 1504. For example, bolts may extend through opposing openings 1508, which may or may not have threads defined by the bases 1506 within the openings 1508, and the bolts may optionally extend into structures (not shown) in which the flywheel 1500 is positioned. In addition, in an embodiment, wiring slots 1510a/1510c and 1510b/1510d (collectively 1510) may be configured to enable winding wire or coils to be extended therethrough when wrapped about the flywheel 1500 for use in driving the rotor 1504 to rotate to store potential energy and drawing electrical power from the rotation of magnets of the rotor 1504 relative to the winding wire (see, for example, FIG. 17A). Rather than using slots 1510, alternative features (e.g., thru-holes) and/or other shapes that enable the winding wire to be wrapped and secured to the respective bases 1506 may be utilized.

With regard to FIG. 15D, an illustration of an illustrative rotor assembly 1504 is shown. The rotor assembly 1504 is formed of multiple components that enable the rotor assembly to perform energy storage in the form of rotational, potential energy that may be converted into electricity by drawing magnetic energy as magnetic flux lines are electromagnetically coupled to the winding coils. The rotor assembly 1504 may be contactless while at rest and while spinning as a result of levitation magnets and the air bearing(s), as further described herein. The rotor assembly 1504 may include the outer casing 1520, optionally formed of carbon fiber, levitation magnet 1522a, and ring magnet gasket 1524a that is disposed between the levitation magnet 1524a and outer casing 1520. A core 1532, which may be formed of nylon or other material that is non-reactive to magnetic fields, may be disposed radially within the levitation magnet 1522a and other components and extend axially through the rotor assembly 1504, as further shown and described herein.

With regard to FIG. 15E, an illustration of illustrative ring magnet gaskets 1524a and 1524b (collectively 1524) is shown. The ring magnet gaskets 1524 may be formed of (space), but may be any other material that enables the gaskets 1524 to perform the same or similar function to fill the space between the ring magnets 1522a and 1522b and the rotor outer casing 1520.

With regard to FIG. 15F, illustration of an illustrative rotor ring magnets assembly with the ring magnet gaskets 1524a having been removed from the rotor assembly 1504 is shown. The ring magnet gaskets 1524a may be positioned in secured in the rotor assembly 1504 using an adhesive, such as a glue.

With regard to FIG. 15G, illustration of the rotor outer casing 1520 is shown. The rotor outer casing 1520 may be formed of carbon fiber, as previously described. The rotor outer casing 1520 may be sized to fit around components of the rotor assembly 1504, including the magnet gaskets 1524.

With regard to FIG. 15H, an illustration of a rotor gasket assembly showing a rotor gasket 1540 without the rotor outer casing 1520 being disposed therein is shown. The rotor gasket 1540 may be secured to an inside wall of the rotor outer casing 1520. In an embodiment, the rotor gasket assembly 1540 may be formed of graphite so as to not interfere with or otherwise respond to magnetic fields produced by rotor magnets 1542a and 1542b (collectively 1542) radially disposed therein. The rotor magnets 1542 may be ferrite magnets, which may operate under high temperature with minimal or no loss of the permanent magnetism. The rotor magnets 1542 may each be formed as a single element having common shapes and dimensions, thereby balancing the rotor assembly 1504 while simplifying manufacturing since the magnets may be identical to one another, thereby being interchangeable. Magnet brackets 1544 may be disposed radially between the rotor magnets 1542 so as to define and maintain separation of the rotor magnets about a central axis of the rotor assembly 1504 located on a center axis of a rotor shaft 1536. The rotor magnets 1542 and magnet brackets 1544 may be engaged with the rotor core 1532 using an adhesive or otherwise. The magnet brackets 1544 may be formed of nylon or other material that does not interfere with magnetic fields produced by the rotor magnets 1542 or levitation magnets 1522, as shown in FIG. 15H.

With regard to FIG. 15H, an illustration of the rotor assembly 1504 having the rotor outer casing 1520 and rotor gasket 1540 having been removed) or prior to being added) as shown. In an embodiment, levitation magnets 1522a and 1522b (collectively 1522) of the rotor assembly 1504 may be circular with an outer diameter slightly smaller than an inner diameter of the rotor and approximately the same as the ring magnet gaskets 1524 and rotor gasket 1540. Axially above and below the levitation magnets 1522 are opposing levitation magnets 1546a and 1546b (collectively 1546) that are configured to be inserted into grooves 1528 of the respective bases 1506. In an embodiment, a spacing of 1 mm between the respective pairs of levitation magnets 1522a/1546a and 1522b/1546b may be utilized to apply a predefined opposing levitation force utilizing the magnetic fields of the respective poles of the magnets. As shown, the levitation magnets, 1522a/1546a may have south(S) magnetic poles opposed to one another, and the levitation magnets 1522b/1546b may have north (N) magnetic poles opposed to one another. The levitation magnets 1522 and 1546 may have magnetic strengths of 450 mT and formed of ferrite material of grade Y35, for example.

With regard to FIG. 15J, an illustration of the levitation magnets 1522 and 1546 separated from the rotor assembly 1504 and bases 1506 is shown. The levitation magnets may be identical to one another.

With regard to FIGS. 15K and 15L, an illustration of a rotor gasket 1540 formed of graphite that has a tubular configuration with an inner diameter that encompasses the rotor magnets 1542 and magnet brackets 1544 shown in FIG. 15L. Axially aligned on opposite ends of the rotor gasket may be the levitation ring magnets 1546 of FIG. 15J. Intersections 1548a and 1548b between the rotor magnets 1542 may have features of each of the magnet brackets 1544 and rotor magnets 1542, as shown in FIGS. 15M-15O.

With regard to FIG. 15M, an illustration of illustrative magnet brackets 1544 independent of the rotor assembly 1504 is shown. The magnet brackets 1544 may have shaped edges 1550a and 1550b (collectively 1550). The shaped edges 1550 may be indentations, such as a V-shape, U-shape, or any other geometric or non-geometric shape, or protrusions with any geometric or non-geometric shape. Inner diameters of the magnet brackets 1544 may be configured to engage an outer diameter of the rotor core 1532. As shown in FIG. 15N, the rotor magnets 1542 may have shaped edges 1552a and 1552b (collectively 1552) that are reciprocal to the shapes of the magnet brackets, thereby enabling the magnet brackets 1544 and rotor magnets 1542 to assist assembly by the edges 1550 and 1552 self-aligning with one another.

With regard to FIG. 15O, an illustration of the illustrative rotor magnets 1542 being independent of the rotor assembly. As previously described, the rotor magnets 1542 may be formed of ferrite so as to operate at higher temperatures and not lose magnetism along with providing weight that assists in providing weight or mass to the rotor assembly 1504.

With regard to FIG. 15P, an illustration of an illustrative shaft-rotor core is shown. The shaft-rotor core may include the rotor core 1532, air bearing tube 1534, and rotor shaft 1536 that, when surrounded by the air bearing tube 1534, forms or defines an air bearing 1538 therebetween. In an embodiment, the air bearing 1538 may be about 10 micrometers (10 μm) or about 0.01 mm between an inner wall of the air bearing tube 1534 and an opposing outer surface of the shaft 1536. Alternative dimensions of the air bearing 1538 that provides the same or similar function may be utilized. In an embodiment, the air bearing 1538 may have no air injection feed zone and be polished so as to be very smooth so as to avoid resistance and increased heat generation due to friction between the air bearing tube 1534 and shaft 1536. Each of the air bearing tube 1534 and rotor shaft 1536 may be formed as a ceramic. In an embodiment, the ceramic is a silica formed of 99.7% aluminum oxide AL₃O₂. By using ceramic, heat generated at the air bearing 1538 due to friction may be drawn from the shaft 1536 because ceramic has a high coefficient of heat transfer. Because the shaft 1536 is connected to the bases 1506 (FIG. 15A) on both ends of the shaft 1536, the heat from the shaft 1536 may be transferred to the bases 1506 for heat discharge. In an embodiment, the bases 1506 may have a high coefficient of heat transfer, such as being the same material as the rotor shaft 1536.

With regard to FIG. 15Q, an illustration of the illustrative rotor core 1532 prior to the air bearing tube 1534 and shaft 1532 being inserted therethrough. The rotor core 1532 may be formed of a number of materials, including nylon, which do not interfere with magnetic fields generated by rotor magnets, as previously described.

With regard to FIG. 15R, an illustration of the rotor shaft 1532 and air bearing tube 1534 between which an air bearing is formed is shown. Each of the rotor shaft 1532 and air bearing tube 1534 may be a common material, such as ceramic, so as to have minimal expansion when heated, thereby maintaining an air bearing 1538 with approximately the same dimensions over temperatures.

With regard to FIG. 15S, an illustration of the air bearing tube 1534 without the shaft being disposed therein is shown.

With regard to FIG. 15T, an illustration of the rotor shaft 1536 independent of the air bearing tube 1534 is shown.

With regard to FIG. 15U, an illustration of an end view of the rotor shaft 1536 being positioned in the air bearing tube 1534 so as to define an air bearing 1538 therebetween is shown. The air bearing 1538 may be set to about 0.01 mm (between an inside wall of the air bearing tube 1534 and outer wall of the rotor shaft 1536). Alternative dimensions may be utilized in accordance with the principles described herein.

With regard to FIGS. 15V and 15V′, an illustrative outer casing 1520 is shown. The outer casing 1520 is tubular and may be formed of a material, such as carbon fiber, which is non-reactive to magnetic fields produced by the rotor assembly 1504 when rotating is shown. In FIGS. 15V and 15V′, curved rotor magnets 1542a and 1542b (collectively 1542) may be positioned within the outer casing 1520 and symmetrically located about a central axis 1554 of the outer casing 1520 so as to ensure balanced rotation of the rotor assembly 1504. The rotor magnets 1542 may be formed of ferrite material, which may provide sufficient weight to provide rotational mass to the rotor assembly 1504, is inexpensive due to having no rare Earth materials, and avoids loss of magnetism at higher temperatures as compared to other permanent magnet material (e.g., Neodymium NdFeB).

As shown in FIG. 15W, rotor gasket (or filler material) 1540 in the shape of a tube may be positioned within the outer casing 1520 and outside the rotor magnets 1542 is shown. Magnet brackets (also a filler material) 1544 may be positioned between and secure the rotor magnets 1542 in position. In an embodiment, the rotor gasket and magnet brackets 1540 and 1544 may be single element formed of a monolithic material to simplify assembly. Alternatively, separate components may be utilized. The rotor gasket and magnet brackets 1540 and 1544 may be formed of nylon, graphite, or any other material that is non-conductive and non-reactive to magnetic fields produced by the magnets 1542, thereby avoiding electro-magnetic interference with performance of the rotor 1504.

With regard to FIG. 15X, an illustration of illustrative rotor core (or filler material) 1532 that is positioned radially within the rotor magnets 1542 and define a thru-hole 1554 that extends completely through the rotor core 1532. The rotor core 1532 may be the same material as one or both of the rotor gasket and magnet brackets 1540 and 1544. If each of the rotor core 1532, rotor gasket 1540, and magnet brackets 1544 are monolithic (i.e., of the same material), then a single structure may be formed defining structure of each of the rotor core 1532, rotor gasket 1540, and magnet brackets 1544 may be formed using a mold, for example. The structure of the rotor core 1532, rotor gasket 1540, and magnet brackets 1544 may be formed and then the rotor magnets 1542 may be slid and glued into place. The structure with the rotor magnets 1542 may thereafter be slid and glued into the outer casing 1520. Because the rotor core 1532, rotor gasket 1540, and magnet brackets 1544 may expand in heat produced during operation of the flywheel 1500 due to friction in the air bearing between the stator (see, for example, FIG. 15B, stator 1502 and rotor 1504) and an optional inner air bearing 1538, as shown in FIG. 15U, for example.

As shown in FIG. 15Y, an illustration of an illustrative assembly process for inserting the rotor shaft 1534 and air bearing tube 1536 forming an air bearing 1538 therebetween is shown. The rotor shaft 1534 and 1536 may be considered an air bearing assembly 1538 that may be inserted into an assembled rotor assembly 1504 or be initially inserted in the core 1532 (see FIG. 15X, for example). The air bearing tube 1536 may be fixedly attached to the core 1532 using an adhesive, such as a glue or epoxy, for example. In forming the rotor assembly 1504, an assembly process may follow any number of steps for configuring each of the components shown in FIGS. 15A-15Y so as to form a fully assembled rotor assembly 1504 using the components arranged to form the rotor assembly 1504 that is contactless in that no wires, brushes, ball bearings, or other physical components contact the rotor assembly 1504 while spinning or even while at rest.

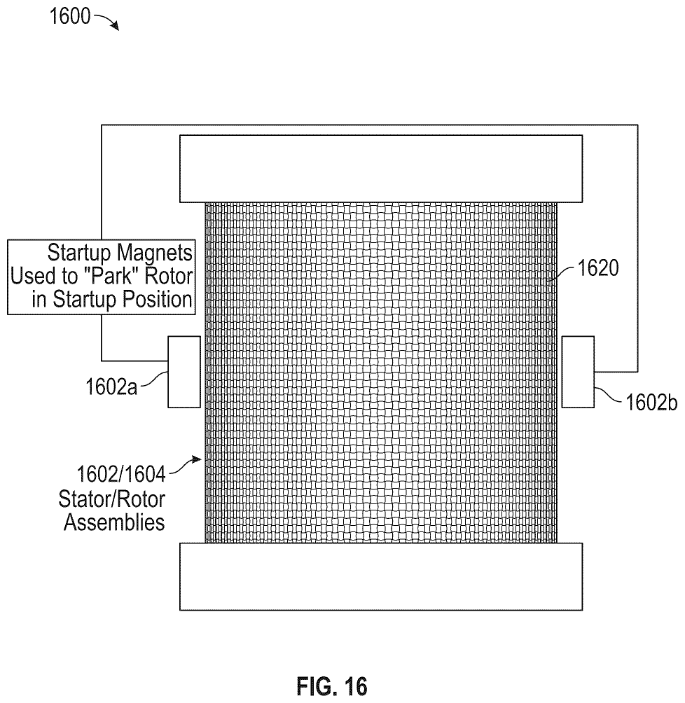

With regard to FIG. 16A, an illustration of an illustrative flywheel 1600 including a stator assembly 1602 and a rotor assembly 1604, which may have the same or similar configuration as the stator and rotor assemblies 1602/1604 as previously shown and described, including startup magnets 1602a and 1602b (collectively 1602) is shown. The startup magnets 1602 may be positioned proximate (e.g., directly attached to, indirectly attached to, or slightly separated from) an outer casing 1620 of a stator 1602 so as to “park” the rotor assembly 1604 by attracting rotor magnets of the rotor assembly 1604, which may be the same or similar to those of FIG. 15L, for example. In an embodiment, the startup magnets 1602 may be positioned on opposite sides of the stator 1602 and have opposite poles (i.e., north and south) facing the stator 1602 so as to attract rotor magnets of opposite polarity (see, for example, FIG. 15I). It should be understood that alternative configurations of the startup magnets 1602 and rotor magnets may be utilized to “park” the rotor assembly 1604 in a position that enables startup rotation by applying an electrical signal to the coil axially wrapped around the stator 1602.

In an embodiment, the startup magnets 1602 may include one or more permanent magnets that have opposite poles facing the outer casing 1620 of the flywheel 1600. The startup magnets 1602 may cause the rotor magnets to be positioned in directions that allows for the rotor assembly 1604 to be activated when electrical signals are applied to motor/generator electromagnetic coils, as further described herein, as opposed to the rotor magnets facing directions that magnetic fields generated by the motor/generator electromagnetic coils are unable to initiate spinning the rotor assembly. The startup magnets 1602 may have a low amount of magnetic strength that is sufficient to attract the rotor magnets, but low enough to enable a small amount (e.g., 5V) of electrical energy flowed through the winding coils may cause magnetic attraction to the rotor magnets to be broken. Moreover, the magnetic strength may also be small enough that has minimal or no impact in rotation of the rotor assembly to avoid loss of efficiency of the flywheel (e.g., less than about 0.5% over 24 hours).

With regard to FIG. 17A, an illustration of an illustrative flywheel assembly 1700 including a stator and rotor assembly 1702 and 1704, motor/generator electromagnetic coils 1706, and electronics 1708 for use in “charging” or spinning up the rotor assembly 1704 is shown. Any number of winding techniques for winding the coils 1706 to have coil parameters (e.g., density, wire gauge, number of windings, cross-section of coil body, etc.) may be utilized. Based on the configuration of the coils 1706, an efficiency of induction of magnetic field from the coils 1706 to the rotor magnets of the rotor assembly 1704 may be provided for driving startup and maximum rotation speed of the rotor assembly 1704. The electronics 1708 are further described with regard to FIG. 18.

With regard to FIG. 17B, an illustration of a set of flywheel assemblies 1700a-1700n (collectively 1700) that have respective electromagnetic coils 1706a-1706n (collectively 1706) in electrical communication with circuitry 1710 for input and output of electrical current to and from the coils 1706 is shown. In an embodiment, the circuitry may include the same or similar electronics as electronics 1708 of FIG. 17A for charging the flywheel assemblies 1700 and output electronics (see FIG. 18) may be used for drawing electrical energy from the charged flywheel assemblies 1700. The input and output of the circuitry 1710 may be operated mutually exclusively in that charging is ON when drawing electrical energy is OFF, and charging is OFF when drawing electrical energy is ON, as further provided with regard to FIG. 18.

With regard to FIG. 18, an electrical schematic of an illustrative kinetic cell or energy storage device 1800 including driver electronics 1802 and a flywheel assembly or motor 1804 is shown. The driver electronics 1802 may include an insulated-gate bipolar transistor (IGBT) 1806 (e.g., IXYP2ON120C3) that is used for controlling the flywheel 1804 in conjunction with an IGBT gate driver 1808 (e.g., Toshiba, TLP350 device). The driver electronics 1802 may further include a magnetic sensor 1810, such as a Hall effect sensor, that senses rotational motion of the rotor of the flywheel 1804. A first power line 1812 may include a source voltage VCC of 12V DC and a second power line 1814 may be ground (GND) at 0V. The IGBT gate driver 1808 receives signals from the magnetic sensor 1810, and an LED signal 1816 drives driver circuitry 1818 that outputs a drive signal 1820 onto a gate line 1822 of the IGBT transistor 1806 to turn ON or OFF the IGBT transistor 1806. The IGBT transistor 1806 may have an emitter line 1824 electrically coupled to the second power line 1814, and a collector line 1826 may be connected to the flywheel 1804. The IGBT transistor 1806 may have a maximum voltage capacity of 1,200 volts, which may define a maximum DC voltage that may cause a drive signal in the form of a magnetic field that may be applied to the flywheel 1804 via coils, such as coils 1706 of FIG. 17A, for “charging” or spinning up the rotor of the flywheel 1804.

The IGBT transistor 1806, in an embodiment, may not include a diode between the collector line 1826 and emitter line 1824 to avoid causing a spike in energy resulting from a reactive voltage. To prevent a voltage spike resulting from reactive voltage of the flywheel 1804, represented as a coil 1828 to represent energy storage of a flywheel, a diode 1830 (e.g., P600S) may be electrically connected in parallel with the coil 1828. A high-power line 1832 may be used to drive or charge up the flywheel 1804. The high-power line 1832 may operate as described in FIG. 6 as input electrical charging power signals 612i₂. In operation, as the flywheel 1804 spins and the magnetic sensor 1810 senses rotation of the motor 1804, the IGBT transistor 1806 may be turned ON and OFF so as to drive the motor 1804 while a rotor magnet is aligned with driver coil(s) (not shown) of the stator (not shown).

In an embodiment, two switches 1834a and 1834b (collectively 1834) may be utilized to control operation operating the flywheel 1834a in (i) a motor charging mode (motor state) or (ii) generator mode (generator state). In particular, when the switches 1834 are closed, the motor charging mode of the flywheel 1804 may have DC voltages ranging from 5V to 1,100V DC may be applied to the flywheel 1804. Using the IGBT gate driver 1808, the drive signal 1820 may be applied while the rotor of the flywheel 1804 is spinning with a particular magnet being magnetically opposed to a magnetic field created by coils of the flywheel 1804 so as to magnetically push the rotor to spin to a maximum amount, which may be upwards of over 200K RPM or more. When the switches 1834 are open, the motor generator mode may draw electrical energy from the spinning flywheel 1804 in the form of AC that may be electrically conducted to a converter and/or inverter to convert the AC from the flywheel 1804 into an electrical signal of a system with which the flywheel 1804 is being used to supply. Each of the energy storage devices 1800 may operate or be configured the same or similar to one another. A controller, such as controller 604 of FIG. 6, may operate to control modes of the energy storage devices 1800 to power up or discharge the energy storage devices 1800. Any of the electronics, electrical components (e.g., IGBT transistor 1804, switches 1834, etc.), and/or electrical conductors used to conduct drive electrical power to the flywheel 1804 and electrical signals from the flywheel 1804 to another electrical circuit (e.g., inverter) via a power bus or other electrical conductors may be considered electronics.

With regard to FIGS. 19A and 19B, illustrations of illustrative rotors charging states 1900 while charging a flywheel 1902 that are being charged using coils 1902 are shown. Magnetic fields 1904 generated by rotor magnets 1906a and 1906b (collectively 1906) and magnetic flux lines spin when the rotor magnets 1906 spin. Hall sensor 1908 may be a SSF41 hall sensor, and configured to sense position of the magnets 1906 based on strength of the magnetic fields 1904 as the rotor magnets 1906 spin. The magnet strength combined with the sensitivity of the hall sensor 1908 and the distance to the magnets 1906 determines the number of degrees the coil remains active. In an embodiment, the hall sensor 1908 may be spaced about 14 mm from the magnets 1906 at closest location to sense the rotation of the rotor magnets 1906. In operation, as shown in FIG. 19A, when the hall sensor 1908 is triggered, the coil 1908 is applied a DC voltage as described in FIG. 18, thereby causing the rotor of the flywheel 1902 to spin as the magnetic fields of the coil 1908 and magnets 1906 are opposing one another and the rotor is pushed/pulled almost 180 degrees (e.g., about 170 degrees during an active cycle) into an aligned position as shown in FIG. 19B.

### Features

One embodiment of an energy storage unit may include multiple kinetic cells configured to be charged by rotating a levitating mass and discharged by generating electrical power utilizing the rotating, levitating mass. A structure may be configured to support the kinetic cells. An electrical bus may be connected to the kinetic cells to conduct electrical signals to and from the kinetic cells to respectively charge and discharge the kinetic cells.

A housing may be supported by the structure and configured to enclose the kinetic cells therein. The structure and housing may define a cabinet. The structure may be configured to support the kinetic cells in vertical alignment with one another. The structure may be configured to support the kinetic cells in rows and columns. The kinetic cells may include at least one air bearing that levitates the mass. The air bearing(s) may include at least one aerodynamic air bearing that enables the mass to self-levitate when rotating. The levitating mass may be a rotor that rotates around a stator. A casing may surround the rotor. The rotor and stator may have an air bearing disposed therebetween, where the rotor and casing may have an air bearing disposed therebetween.

The air bearing(s) may have a clearance below about 0.7 mm. The air bearing(s) may operate at air pressures of 1 atmosphere. The casing may be formed of stainless steel. Height and diameter of the casing may be approximately the same. End walls may be connected to the casing and stator to form a closed, limited passive air chamber. The casing may be carbon fiber. The rotor may be an electrical steel iron alloy or ferrite. Each of the kinetic cells may have unique network addresses so as to be individually network addressable. A number of the kinetic cells may be more than 10 kinetic cells. A number of the kinetic cells may be more than 100. A number of the kinetic cells may be at least 1000.

A maximum dimension of the kinetic cells may be less than about 4-inches (about 10 cm) long. The kinetic cells may include ferrite inside coils to enhance flux density and reduce eddy currents. The kinetic cells may be configured as brushless DC motors. The energy storage unit may include a driver configured to apply a 15 kHz charging signal to charge the kinetic cells. The driver may be configured to charge the kinetic cells to above 200,000 revolutions per minute (RPM). The kinetic cells may be collectively configured to output at least 200 KWh of electrical energy. Each kinetic cell may be configured to output at least 200 Wh of electrical energy.

In an embodiment, multiple electrical switches may be configured to enable the kinetic cells to be selectably charged and discharged. One or more electrical conductors may be in selective electrical communication with an electrical system inclusive of a propulsion device. A canister may surround each of the kinetic cells. The canister may be formed of Kevlar®, such as Kevlar EXO™ from DuPont.

Another embodiment of an energy storage device may include a rotor including a mass configured to be levitated and rotated, a stator, and a casing disposed around the rotor and stator, and configured to seal the rotor and stator therein.

The rotor may include multiple magnets, and wherein the stator may include multiple coils electromagnetically coupled to the magnets that generate electricity when the rotor is rotated. The rotor and stator may be configured to generate an air bearing that causes the rotor to be levitated when the rotor is rotated. The air bearing may be an aerodynamic air bearing that causes the mass to self-levitate when rotating. The rotor may encircle and rotate around the stator. The casing may have a wall that encircles the rotor. The casing may further include end walls that extend between the stator and casing, thereby encasing the rotor within a hollow region defined by the end walls and wall of the casing that forms a donut-shaped casing that forms a closed, limited passive air chamber.

The rotor may be encircled by the stator. The casing may be formed of carbon fiber. The rotor may be formed of electrical steel alloy or ferrite. The rotor and stator may further be configured to generate an air bearing between one another, thereby maintaining a substantially constant distance between the rotor and stator while the rotor is rotating, where the rotor and casing may further be configured to generate an air bearing between one another, thereby maintaining a substantially constant distance between the rotor and casing while the rotor is rotating.

The air bearings have an air gap clearance below about 0.7 mm. The air bearings may operate at air pressures of 1 atmosphere. The casing may be formed of stainless steel. The height and diameter of the casing may be approximately the same.

The device may further include electronics that are configurable with a unique network address so as to be individually network addressable. A maximum dimension of the rotor and stator may be less than about 4-inches (about 10 cm). Ferrite may be disposed inside the coils to enhance flux density and reduce eddy currents. The configuration of the rotor and stator may define a brushless DC motor. The rotor and stator may be configured to be rotated in response to a 15 kHz charging signal being received. The rotor may be configured to rotate at least 200,000 revolutions per minute (RPM). Rotation of the rotor may enable 250 Wh of electrical energy to be output.

The device may further include a canister formed of Kevlar® that encloses the casing. The Kevlar may be Kevlar® EXO™ from DuPont. The mass may include 1 pole pair of magnets, and wherein the stator includes coils, and wherein the magnets and coils are electromagnetically coupled with one another to cause an electric current to be generated when the rotor rotates relative to the stator.

One embodiment of a system may include an electrical power system configured to conduct electrical power to electrical equipment, at least one energy storage unit, including multiple kinetic cells configured to be charged by rotating a levitating mass and discharged by generating electrical power utilizing the rotating levitating mass. A structure may be configured to support the kinetic cells. At least one electrical conductor may be connected to the kinetic cells of the energy storage unit(s), the electrical conductor(s) may be configured to conduct electrical signals to and from the kinetic cells of the energy storage unit(s) to respectively charge and discharge the kinetic cells of the respective energy storage unit(s), the electrical conductor(s) may be further in electrical communication to conduct electrical power from the storage unit(s) to the electrical power system. The electrical equipment may include electric thrusters to propel the system in water.

One embodiment of a method of charging and discharging an energy storage unit may include applying an electrical signal to charge multiple kinetic cells contained in the energy storage unit by rotating a levitating mass contained within each kinetic cell. An electrical power signal may be generated by collectively utilizing the rotating levitating masses, thereby discharging the rotating, levitating masses. The electrical power signal may be conducted to an electrical power system.

Applying an electrical signal may include applying an alternating current (AC) electrical signal that, when applied to the kinetic cells when at a zero-spin rate, causes rotors of the kinetic cells to self-levitate by forming an air bearing. The process may further include causing the electrical signal to be selectably applied to the rotating masses, thereby causing a portion of the kinetic cells to be charged. Moreover, the process may cause a portion of the kinetic cells to discharge, thereby generating the electrical power signal from the collective portion of the kinetic cells being discharged.

### Another Embodiment

Another embodiment of an energy storage unit may include a flywheel that includes a stator assembly. A rotor assembly may be positioned radially within the stator assembly, and include multiple rotor magnets. The rotor assembly may utilize an air bearing aligned with a central axis of the stator assembly to rotate about a central axis. A coil of one or more conductive wires may be axially wrapped around the stator assembly. Circuitry may be in electrical communication with the coil, and be configured to selectably (i) apply a voltage to the coil to cause a motor magnetic field to cause at least one of the rotor magnets of the rotor assembly to rotate the rotor assembly within the stator assembly, (ii) receive a generator magnetic field from the rotor magnets while the rotor assembly is rotating, and (iii) conduct an electric current induced on the coil by the magnetic field from the coil to at least one electrical conductor.

In an embodiment, the stator assembly may include a tubular internal wall and a tubular external wall, where the rotor assembly may include a tubular external wall, and wherein the air bearing is defined between the internal wall of the stator assembly and external wall of the rotor assembly.

The rotor assembly may further include a tubular internal wall, and the rotor may further include a rotor shaft including an external wall, the rotor shaft, having a central axis coaxial with the central axis of the stator assembly and the rotor assembly. The rotor shaft may extend laterally through the tubular internal wall of the rotor assembly, a space defined between the external wall of the rotor shaft and the internal wall of the rotor assembly defining a second air bearing.

The energy storage unit may further include an air bearing tube fixedly positioned in a center region of the rotor assembly and defining the tubular internal wall, where the air bearing tube and the rotor shaft may be formed of the same material. The material of the air bearing tube and the rotor shaft may be ceramic. The ceramic may be alumina.

The energy storage unit may further include a first base defining a first end wall of the flywheel, and a second base defining a second end wall of the flywheel. The rotor shaft may be fixedly connected to the first and second bases so as to enable heat conducted from the rotor shaft to be transferred thereto. The first and second bases may be formed of the same material as the rotor shaft. The first and second bases may define an indentation sized to frictionally fit (i) each end of the rotor shaft and (ii) adhesive utilized to fixedly connect the first and second bases to each of the respective ends of the rotor shaft.

The energy storage unit may further include a first pair of levitation magnets, and a second pair of levitation magnets. Each of the first and second pair of levitation magnets may be disposed on opposite ends of the rotor assembly and configured to levitate the rotor assembly from the respective first and second bases. The first and second pairs of levitation magnets may be circular.

The first and second bases may include circular grooves that are concentric with the indentation of the respective bases, where a first levitation magnet of the first pair of levitation magnets is fixedly connected within the circular groove of the first base. A first levitation magnet of the second pair of levitation magnets may be fixedly connected within the circular groove of the second base. A second levitation magnet of the first pair of levitation magnets may be fixedly attached to the rotor assembly to a first end of the rotor assembly. A second levitation magnet of the second pair of levitation magnets may be fixedly attached to a second end of the rotor assembly. A magnetic pole of the levitation magnet of the first pair of levitation magnets may match a magnetic pole of the second levitation magnet of the first pair of levitation magnets that faces the rotor assembly. A magnetic pole of the first levitation magnet of the second pair of levitation magnets may match a magnetic pole of the levitation magnet of the second pair of levitation magnets that faces the rotor assembly.

The matching magnetic pole of the first pair of levitation magnets may be a north magnetic pole, and the matching magnetic pole of the second pair of levitation magnets is a south magnetic pole.

Each of the first and second bases may define a second groove concentric with the first groove and the indentation, and the stator assembly may be tubular and define first and second end walls having circular profiles configured to be fixedly connected to the respective first and second bases within the second grooves, thereby enclosing the rotor within a tubular cavity defined by the stator assembly and first and second bases at each end of the stator assembly. The cavity may be at ambient air pressure.

The circuitry may include at least one switch that, when in a motor state, enables the rotor assembly of the flywheel to be charged by increasing rotational speed thereof, and, when in a generator state, enables the rotor assembly of the flywheel to be discharged by drawing electric current from the coil, thereby causing the rotor assembly to be slowed.

The coil may include an input conductor portion and an output conductor portion. Additionally, an insulated-gate bipolar transistor (IGBT) may be electrically coupled to a first end of the coil such that a voltage applied to the input conductor portion of the coil (i) enables a current to flow through the IGBT and cause the rotor assembly to charge when in an ON state, and (ii) prevents the current to flow through the IGBT when in an OFF state.

The electronics may include driver electronics configured (i) to sense rotation of the rotor assembly and (ii) to apply a magnetic drive signal to the coil to cause a magnetic field to be applied to the rotor assembly for a portion of a rotation of the rotor assembly. The electronics may further include a Hall sensor approximate the stator assembly, and be configured to sense a magnet of the rotor assembly. The electronics may further include startup magnets disposed proximate the stator assembly to cause the rotor assembly to retain the rotor magnets in a startup position that enables the circuitry to initiate rotation of the rotor assembly. The startup magnets may include a pair of startup magnets that are disposed on opposite sides of the stator assembly. The rotor magnets may be two in number, where a first rotor magnet and a second rotor magnet have opposite magnetic poles and the startup magnets being configured to attract the respective first and second rotor magnets that have opposite poles that face the startup magnets.

Another embodiment of an energy storage unit may include a stator defined by an internal wall, an external wall, a first end, and a second end. A rotor may be defined by an internal wall, an external wall, a first end, and a second end. The external wall of the rotor may be disposed within the internal wall of the stator such that an air bearing is formed within an air gap therebetween. A coil may extend longitudinally around the stator and rotor, and configured to collect magnetic energy generated when the rotor is rotating. A first base may be connected to the first end of the stator, and a second base may be connected to the second end of the stator. The first and second bases may seal the rotor within a cavity defined by (i) the internal wall of the stator, (ii) the first base, and (iii) the second base.

The first and second bases may define inside walls with respective circular grooves. A pair of ring magnets may be positioned in and retained by the respective grooves, where the ring magnets have magnetic poles that repel corresponding ring magnets positioned at ends of the rotor such that the rotor is axially suspended within the cavity by the pair of ring magnets, thereby causing the rotor to be contactless when at rest and when rotating within the stator.

The rotor may include a casing having a tubular shape and defining a center hollow region. A first magnet may have an arcuate shape and be disposed within the hollow region. A second magnet may have an arcuate shape and be disposed within the cavity. A set of magnet brackets may be disposed radially between the first and second magnets to maintain radial separation therebetween. The casing may be a carbon fiber material. The first and second magnets may be ferrite magnets.

The energy storage unit may further include a rod having a side wall surface. A tube may be configured to be disposed around the rod, where the tube defines an inner wall and an outer wall. The tube, when disposed about the rod, may form a second air bearing between the sidewall surface of the rod and inner wall of the tube. The inside walls of the first and second bases may further define respective cavities that, when the first and second bases are connected to the stator, are axially aligned in an opposition with one another.

The first and second magnets may be arc-shaped and substantially identical to one another. The first and second magnets may have opposite magnetic polarity. The rod and tube may be formed of the same material. The material may ceramic, such as alumina. The first and second bases may be formed of the same material as the rod, thereby enabling heat to be transferred from the rod to the respective bases when the rotor is spinning.

### Methodologies

One embodiment of a method of manufacturing an energy storage unit may include forming a flywheel including forming a stator assembly having a tubular shape. A rotor assembly including a plurality of rotor magnets may be formed. The rotor assembly may be disposed radially within the stator assembly. An air bearing that enables the rotor assembly to rotate in a contactless manner may be formed. A coil of one or more conductive wires may be axially wound around the stator assembly with the rotor assembly disposed therein.

Forming an air bearing may include forming an air bearing between an external wall of the rotor assembly and an internal wall of the stator assembly. A first base may be connected to one end of the stator assembly so as to define a first end wall of the flywheel. A second base may be connected to the other end of the stator assembly to define a second end wall of the flywheel such that the stator assembly, first base, and second base define a cavity within which the rotor assembly rotates. The cavity may be at ambient air pressure.

An air bearing tube may be connected within a center portion of the rotor assembly. A rotor shaft may be inserted through the air bearing tube such that a space between the rotor shaft and air bearing tube may define a second air bearing. The rotor shaft may be fixedly connected to the first and second bases so as to enable heat conducted from the rotor shaft to be transferred thereto.

The process may further include electrically connecting circuitry with the coil to control electricity to (i) apply a voltage to the coil to cause a motor magnetic field to cause at least one of the rotor magnets of the rotor assembly to rotate the rotor assembly within the stator assembly, (ii) receive a generator magnetic field from the rotor magnets while the rotor assembly is rotating, and (iii) conduct an electric current induced on the coils by the magnetic field from the coils to at least one electrical conductor external from the energy storage unit.

One embodiment of operating an energy storage unit may include applying a direct current (DC) voltage to a coil configured to cause a magnetic field to drive rotation of a rotor assembly (i) inclusive of a plurality of permanent magnets and (ii) disposed within a stator assembly of a flywheel to rotate, the rotation of the rotor assembly being facilitated by an air bearing between the rotor assembly and stator assembly. Application of the DC voltage to the coil may be stopped. An electric current may be generated in response to a rotating magnetic field produced by the rotating permanent magnets of the rotor assembly passing through the coil. The electric current may be output from the energy storage unit.

Applying a direct current voltage to a coil configured to cause a magnetic field to drive a rotor assembly inclusive of a plurality of permanent magnets may include applying a direct current voltage to a coil configured to cause a magnetic field to drive a rotor assembly inclusive of two permanent magnets, the two permanent magnets having matched physical shape and weight. The process may further include sensing rotation of the rotor assembly, and causing the DC voltage to be applied in response to determining that the magnetic field is aligned with one of the permanent magnets to cause the rotor assembly to rotate. Causing the DC voltage to be applied may include driving a gate voltage of a transistor electrically coupled in series with the coil to enable current to flow through the transistor and coil. Driving a gate voltage of a transistor may include driving a gate voltage of an insulated-gate bipolar transistor (IGBT). Applying a DC voltage may include applying a DC voltage ranging from 5 volts to 1100 volts. Stopping application of the DC voltage to the coil may include switching at least one switch to change from a motor mode in which the rotor assembly is being driven to spin to a generator mode in which the electric current is being generated by the rotation of the rotor assembly and permanent magnets thereof.

Causing rotation of the rotor assembly may further include driving rotation of the rotor assembly by utilizing a second air bearing between (i) a rotor shaft that extends along a central axis of the rotor and stator and (ii) an air bearing tube that is fixedly connected to the rotor assembly for form an internal wall thereof. Driving rotation of the rotor assembly by utilizing a second air bearing may include driving rotation of the rotor assembly by utilizing a second air bearing in which an internal wall of the air bearing tube and an external wall of the rotor shaft opposing the internal wall of the air bearing tube are circular and independent of any indentations or grooves. Driving rotation of the rotor assembly by utilizing a second air bearing may include driving rotation of the rotor assembly by utilizing a second air bearing that has about a 0.01 mm spacing.

The foregoing method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

What is claimed is:

1. An energy storage unit, comprising:
a plurality of kinetic cells configured to be charged by rotating a levitating mass and discharged by generating electrical power utilizing the rotating, levitating mass;
a structure configured to support the kinetic cells; and
an electrical bus connected to the kinetic cells to conduct electrical signals to and from the kinetic cells to respectively charge and discharge the kinetic cells.

2. The energy storage unit according to claim 1, further comprising a housing supported by the structure and configured to enclose the kinetic cells therein.

3. The energy storage unit according to claim 2, wherein the structure and housing define a cabinet.

4. The energy storage unit according to claim 1, wherein the structure is configured to support the kinetic cells in vertical alignment with one another.

5. The energy storage unit according to claim 1, wherein the structure is configured to support the kinetic cells in rows and columns.

6. The energy storage unit according to claim 1, wherein the kinetic cells include at least one air bearing that levitates the mass.

7. The energy storage unit according to claim 6, wherein the at least one air bearing is at least one aerodynamic air bearing that enables the mass to self-levitate when rotating.

8. The energy storage unit according to claim 7, wherein the levitating mass is a rotor that rotates around a stator.

9. The energy storage unit according to claim 8, further comprising a casing surrounding the rotor.

10. The energy storage unit according to claim 9, wherein the rotor and stator have an air bearing disposed therebetween, and wherein the rotor and casing have an air bearing disposed therebetween.

11. The energy storage unit according to claim 10, wherein the at least one air bearing has a clearance below about 0.7 mm.

12. The energy storage unit according to claim 10, wherein the at least one air bearing operates at an air pressure of 1 atmosphere.

13. The energy storage unit according to claim 9, wherein the casing is formed of stainless steel.

14. The energy storage unit according to claim 9, wherein height and diameter of the casing are approximately the same.

15. The energy storage unit according to claim 9, further comprising end walls connected to the casing and stator to form a closed, limited passive air chamber.

16. The energy storage unit according to claim 9, wherein the casing is carbon fiber.

17. The energy storage unit according to claim 16, wherein the rotor is an electrical steel iron alloy or ferrite.

18. The energy storage unit according to claim 1, wherein each of the kinetic cells have unique network addresses so as to be individually network addressable.

19. The energy storage unit according to claim 1, wherein a number of the plurality of kinetic cells is more than 10 kinetic cells.

20. The energy storage unit according to claim 1, wherein a number of the plurality of kinetic cells is more than 100.

21. The energy storage unit according to claim 1, wherein a number of the plurality of kinetic cells is at least 1000.

22. The energy storage unit according to claim 1, wherein a maximum dimension of the kinetic cells is less than about 4-inches (about 10 cm) long.

23. The energy storage unit according to claim 1, wherein the kinetic cells include ferrite inside coils to enhance flux density and reduce eddy currents.

24. The energy storage unit according to claim 1, wherein the kinetic cells are configured as brushless DC motors.

25. The energy storage unit according to claim 1, further comprising a driver configured to apply a 15 kHz charging signal to charge the kinetic cells.

26. The energy storage unit according to claim 25, wherein the driver is configured to charge the kinetic cells to above 200,000 revolutions per minute (RPM).

27. The energy storage unit according to claim 26, wherein the kinetic cells are collectively configured to output at least 200 KWh of electrical energy.

28. The energy storage unit according to claim 26, wherein each kinetic cell is configured to output at least 200 Wh of electrical energy.

29. The electrical storage unit according to claim 1, further comprising a plurality of electrical switches configured to enable the kinetic cells to be selectably charged and discharged.

30. The electrical storage unit according to claim 1, wherein the one or more electrical conductors are in selective electrical communication with an electrical system inclusive of a propulsion device.

31. The electrical storage unit according to claim 1, further comprising a canister surrounding each of the kinetic cells.

32. The electrical storage unit according to claim 31, wherein the canister is formed of Kevlar®.

33. The electrical storage unit according to claim 32, wherein the Kevlar is Kevlar EXO™ from DuPont.

34-114. (canceled)

115. The energy storage unit according to claim 7, wherein the levitating mass is a rotor that rotates radially within a stator.
